(19) United States
(12) Patent Application Publication
(10) Pub. No.: US 2021/0099265 A1
(43) Pub. Date: Apr. 1, 2021

(54) PHASE TRACKING METHOD AND APPARATUS FOR SIDELINK COMMUNICATION IN WIRELESS COMMUNICATION SYSTEM

(71) Applicant: Samsung Electronics Co., Ltd., Suwon-si (KR)

(72) Inventors: Cheolkyu SHIN, Suwon-si (KR); Hyunseok RYU, Suwon-si (KR); Jonghyun BANG, Suwon-si (KR); Jinyoung OH, Suwon-si (KR)

(21) Appl. No.: 17/037,253

(22) Filed: Sep. 29, 2020

(30) Foreign Application Priority Data
Sep. 30, 2019 (KR) 10-2019-0121203
Oct. 28, 2019 (KR) 10-2019-0134956

(51) Int. Cl. H04L 5/00; H04W 72/02; H04B 7/06; H04W 72/04

(52) U.S. Cl. CPC H04L 5/0051; H04W 72/02; H04W 72/0446; H04W 72/0453; H04B 7/0626

(57) ABSTRACT

The disclosure relates to a communication technique and a system for fusing a 5th-generation (5G) or pre-5G communication system for supporting a higher data rate than that of a 4th-generation (4G) communication system, such as long-term evolution (LTE), with IoT technology. The disclosure can be applied to intelligent services (e.g., smart home, smart building, smart city, smart car or connected car, healthcare, digital education, retail, security- and safety-related services, etc.), based on 5G communication technology and IoT-related technology. According to various embodiments of the disclosure, a method and apparatus for performing phase tracking in a process in which a vehicle terminal supporting vehicle communication (V2X) exchanges information with another vehicle terminal and/or a pedestrian portable terminal using a sidelink can be provided.

### CROSS-REFERENCE TO RELATED APPLICATIONS

This application is based on and claims priority under 35 U.S.C. § 119 of a Korean Patent Application Number 10-2019-0121203, filed on Sep. 30, 2019, in the Korean Intellectual Property Office, and a Korean Patent Application Number 10-2019-0134956, filed on Oct. 28, 2019, in the Korean Intellectual Property Office, the disclosure of each of which is incorporated by reference herein in its entirety.

### BACKGROUND

### 1. Field

The disclosure relates to a mobile communication system, and more particularly, to a method and apparatus for performing phase tracking in a process in which a vehicle terminal supporting vehicle-to-everything (hereinafter, V2X) communication transmits and receives information using a sidelink with another vehicle terminal and/or a pedestrian portable terminal.

### 2. Description of Related Art

To meet the demand for wireless data traffic having increased since deployment of 4G communication systems, efforts have been made to develop an improved 5G or pre-5G communication system. Therefore, the 5G or pre-5G communication system is also called a “Beyond 4G Network” or a “Post LTE System”.

The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G communication systems.

In addition, in 5G communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancellation and the like.

In the 5G system, hybrid FSK and QAM modulation (FQAM) and sliding window superposition coding (SWSC) as an advanced coding modulation (ACM), and filter bank multi carrier (FBMC), non-orthogonal multiple access(NOMA), and sparse code multiple access (SCMA) as an advanced access technology have also been developed.

For the 5G system, studies are being conducted to support a wider variety of services than the existing 4G system. For example, the most representative services of the 5G system include an enhanced mobile broadband (eMBB) service, an ultra-reliable and low latency communication (URLLC) service, a massive machine type communication (mMTC) service, an evolved multimedia broadcast/multicast service (eMBMS), and the like. Further, a system for providing the URLLC service may be referred to as a URLLC system, and a system for providing the eMBB service may be referred to as an eMBB system. In addition, the terms “service” and “system” may be used interchangeably.

Among these services, the URLLC service is a service that is newly considered in the 5G system, in contrast to the existing 4G system, and requires to satisfy ultrahigh reliability (e.g., packet error rate of about 10-5) and low latency (e.g., about 0.5 msec) conditions compared to the other services. In order to satisfy such strict requirements, the URLLC service may need to apply a transmission time interval (TTI) that is shorter than that of the eMBB service, and various operating methods using this are under consideration.

The Internet, which is a human centered connectivity network where humans generate and consume information, is now evolving to the Internet of things (IoT) where distributed entities, such as things, exchange and process information without human intervention. The Internet of everything (IoE), which is a combination of the IoT technology and the big data processing technology through connection with a cloud server, has emerged. As technology elements, such as “sensing technology”, “wired/wireless communication and network infrastructure”, “service interface technology”, and “security technology” have been demanded for IoT implementation, a sensor network, a machine-to-machine (M2M) communication, machine type communication (MTC), and so forth have been recently researched.

Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing information technology (IT) and various industrial applications.

In line with this, various attempts have been made to apply 5G communication systems to IoT networks. For example, technologies such as a sensor network, machine type communication (MTC), and machine-to-machine (M2M) communication may be implemented by beamforming, MIMO, and array antennas. Application of a cloud radio access network (RAN) as the above-described big data processing technology may also be considered an example of convergence of the 5G technology with the IoT technology.

The above information is presented as background information only to assist with an understanding of the disclosure. No determination has been made, and no assertion is made, as to whether any of the above might be applicable as prior art with regard to the disclosure.

### SUMMARY

The disclosure relates to a wireless communication system, and more particularly, to a method and apparatus for performing phase tracking in a process in which a vehicle terminal supporting V2X exchanges information using a sidelink with another vehicle terminal and/or a pedestrian portable terminal. In particular, when a communication system operates at a high frequency, decoding of a received signal may become inaccurate due to phase noise. To overcome this problem, it is possible to transmit and receive a phase-tracking reference signal (PTRS) to track the phase noise in the sidelink signal. In the disclosure, a method of generating, transmitting and receiving PTRS in a sidelink is provided. This disclosure provides the operation of a base station and a terminal according to the method proposed in the disclosure.

The technical subjects pursued in the disclosure may not be limited to the above mentioned technical subjects, and other technical subjects which are not mentioned may be clearly understood, through the following descriptions, by those skilled in the art to which the disclosure pertains.

In accordance with an aspect of the present disclosure, a method performed by a first terminal in a wireless communication system is provided. The method comprises transmitting, to a second terminal, first control information; transmitting, to the second terminal, second control information; and transmitting, to the second terminal, a data based on the first control information and the second control information, wherein symbols for transmitting the second control information starts a first symbol carrying an associated demodulation reference signal (DM-RS) for a physical sidelink shared channel.

In one embodiment, the method further comprises determining symbols of the DM-RS based on a duration of a scheduled resource for transmission of the first control information and the data, a determined DM-RS time pattern, and a duration of a physical sidelink control channel.

In one embodiment, the method further comprises receiving, from a base station, configuration information for a sidelink phase tracking reference signal (PTRS) per sidelink resource pool, and wherein the configuration information for the sidelink PTRS includes at least one of a PTRS frequency density, a PTRS time density, or a PTRS resource element offset.

In one embodiment, resource elements for transmitting the second control information are not used for transmission of at least one of the DM-RS or the sidelink PTRS.

In one embodiment, the sidelink PTRS is mapped to resource elements not used for transmission of a sidelink channel state information reference signal (CSI-RS), the first control information, nor the DM-RS.

The present disclosure also provides a method performed by a second terminal in a wireless communication system. The method comprises receiving, from a first terminal, first control information; receiving, from the first terminal, second control information; and receiving, from the first terminal, a data based on the first control information and the second control information, wherein symbols for transmitting the second control information starts a first symbol carrying an associated demodulation reference signal (DM-RS) for a physical sidelink shared channel.

In one embodiment, the method further comprises determining symbols of the DM-RS based on a duration of a scheduled resource for transmission of the first control information and the data, DM-RS time pattern information received from the first terminal, and a duration of a physical sidelink control channel.

In one embodiment, resource elements for receiving the second control information are not used for transmission of at least one of the DM-RS or a sidelink phase tracking reference signal (PTRS).

In one embodiment, a sidelink phase tracking reference signal (PTRS) is mapped to resource elements not used for transmission of a sidelink channel state information reference signal (CSI-RS), the first control information, nor the DM-RS.

In one embodiment, the method further comprises receiving, from a base station, configuration information for a sidelink phase tracking reference signal (PTRS) per sidelink resource pool, and wherein the configuration information for the sidelink PTRS includes at least one of a PTRS frequency density, a PTRS time density, or a PTRS resource element offset.

The present disclosure also provides a first terminal in a wireless communication system. The first terminal comprises a transceiver; and a controller configured to: transmit, to a second terminal via the transceiver, first control information, transmit, to the second terminal via the transceiver, second control information, and transmit, to the second terminal via the transceiver, a data based on the first control information and the second control information, wherein symbols for transmitting the second control information starts a first symbol carrying an associated demodulation reference signal (DM-RS) for a physical sidelink shared channel.

The present disclosure also provides a second terminal in a wireless communication system. The second terminal comprises a transceiver; and a controller configured to: receive, from a first terminal via the transceiver, first control information, receive, from the first terminal via the transceiver, second control information, and receive, from the first terminal via the transceiver, a data based on the first control information and the second control information, wherein symbols for transmitting the second control information starts a first symbol carrying an associated demodulation reference signal (DM-RS) for a physical sidelink shared channel.

According to the apparatus and method according to the disclosure, when phase tracking is performed in sidelink communication, transmission in the sidelink can be supported more stably.

Effects obtainable from the disclosure may not be limited to the above mentioned effects, and other effects which are not mentioned may be clearly understood, through the following descriptions, by those skilled in the art to which the disclosure pertains.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the disclosure and its advantages, reference is now made to the following description taken in conjunction with the accompanying drawings, in which like reference numerals represent like parts, and wherein:

FIG. 1A illustrates an example of scenarios for sidelink communication in a wireless communication system according to various embodiments, FIG. 1B illustrates an example of scenarios for sidelink communication in a wireless communication system according to various embodiments, FIG. 1C illustrates an example of scenarios for sidelink communication in a wireless communication system according to various embodiments, and FIG. 1D illustrates an example of scenarios for sidelink communication in a wireless communication system according to various embodiments;

FIG. 2A illustrates an example of a transmission method of sidelink communication in a wireless communication system according to various embodiments, and FIGS. 2B-2C illustrate examples of a transmission method of sidelink communication in a wireless communication system according to various embodiments;

FIG. 3 illustrates an example of a sidelink resource pool in a wireless communication system according to various embodiments;

FIG. 4 illustrates an example of signal flow for allocating sidelink transmission resources in a wireless communication system according to various embodiments;

FIG. 5 illustrates another example of signal flow for allocating sidelink transmission resources in a wireless communication system according to various embodiments;

FIG. 6 illustrates an example of a channel structure of a slot used for sidelink communication in a wireless communication system according to various embodiments;

FIG. 7 illustrates a diagram illustrating a channel-state information framework of an NR sidelink system according to an embodiment;

FIG. 8 illustrates a diagram for explaining a PTRS transmission and reception procedure in a sidelink according to an embodiment;

FIGS. 9A to 9N illustrate exemplary diagrams for explaining a method for transmitting PTRS according to various embodiments;

FIG. 10 illustrates a diagram illustrating the structure of a CCE supported by a PSCCH through which SCI is transmitted according to various embodiments;

FIG. 11 illustrates a signal flow diagram illustrating a method of performing beam operation through CSI-RS resource configuration in the case of non-codebook transmission according to an embodiment;

FIG. 12 illustrates the configuration of a terminal in a wireless communication system according to various embodiments; and

FIG. 13 illustrates the configuration of a base station in a wireless communication system according to various embodiments.

### DETAILED DESCRIPTION

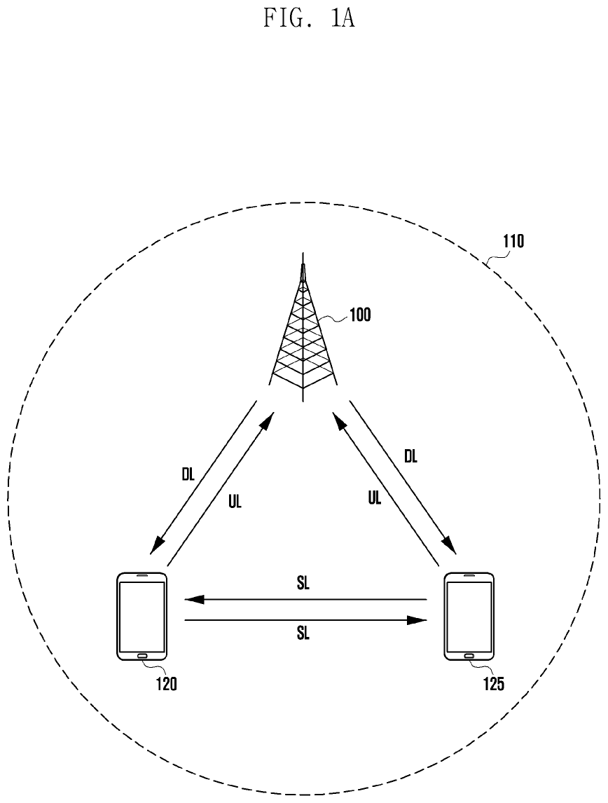

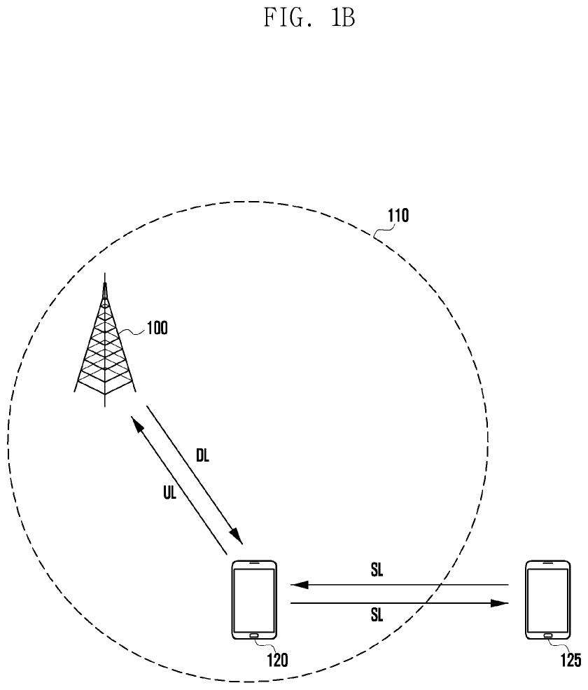

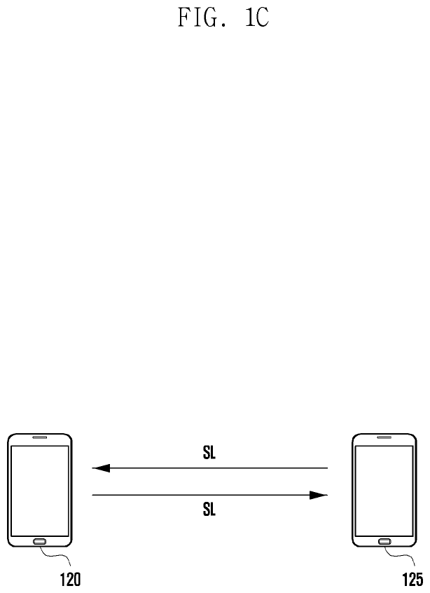

FIGS. 1A through 13, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The terms used in the disclosure are only used to describe specific embodiments, and are not intended to limit the disclosure. A singular expression may include a plural expression unless they are definitely different in a context. Unless defined otherwise, all terms used herein, including technical and scientific terms, have the same meaning as those commonly understood by a person skilled in the art to which the disclosure pertains. Such terms as those defined in a generally used dictionary may be interpreted to have the meanings equal to the contextual meanings in the relevant field of art, and are not to be interpreted to have ideal or excessively formal meanings unless clearly defined in the disclosure. In some cases, even the term defined in the disclosure should not be interpreted to exclude embodiments of the disclosure.

Hereinafter, various embodiments of the disclosure will be described based on an approach of hardware. However, various embodiments of the disclosure include a technology that uses both hardware and software, and thus the various embodiments of the disclosure may not exclude the perspective of software.

Hereinafter, the disclosure relates to an apparatus and a method for performing phase tracking in a wireless communication system. Specifically, the disclosure is for tracking phase noise in sidelink communication between terminals, and relates to an apparatus and a method for generating and transmitting a phase-tracking reference signal (PTRS).

In the following description, terms referring to a signal, terms referring to a channel, terms referring to control information, terms referring to network entities, terms referring to components of a device, etc., are exemplary, and are selected for convenience of description. Therefore, the disclosure is not limited the terms used below, and other terms having equivalent technical meanings may be used.

In the following description, “physical channel” and “signal” may be used interchangeably with “data” or “control signal”. For example, “physical downlink shared channel (PDSCH)” is a term that refers to a physical channel through which data is transmitted, but “PDSCH” may also be used to refer to data. That is, in the disclosure, the expression “to transmit a physical channel” may be interpreted equivalently to the expression “to transmit data or signals through a physical channel”.

Hereinafter, in the disclosure, “higher-layer signaling” refers to a signal transmission method that is transmitted from a base station to a terminal using a downlink data channel of a physical layer or from a terminal to a base station using an uplink data channel of a physical layer. Higher-layer signaling may be understood as radio resource control (RRC) signaling or media access control (MAC) control element (CE) signaling.

In addition, in the disclosure, in order to determine whether a specific condition is satisfied or fulfilled, the expression “greater than” or “less than” may be used, but this is only a description for expressing an example, and does not exclude the cases of “equal to or more” or “equal to or less”. Conditions described as “equal to or more than” may be replaced with “greater than”, conditions described as “equal to or less than” and conditions described as “less than”, and conditions described as “equal to or more than, and less than” may be replaced with “greater than, and equal to or less than”.

In addition, the disclosure describes various embodiments using terms used in some communication standards (e.g., the 3rd-generation partnership project (3GPP)), but this is only an example for description. Various embodiments of the disclosure may be easily modified and applied to other communication systems.

In the disclosure, a transmitting terminal is a terminal that transmits sidelink data and sidelink control information and/or a terminal that receives sidelink feedback information. In addition, in the disclosure, a receiving terminal is a terminal that receives sidelink data and sidelink control information and/or a terminal that transmits sidelink feedback information.

Various attempts have been made to apply the 5G communication system to IoT networks. For example, technologies such as sensor networks, machine-to-machine (M2M) communication, and machine-type communication (MTC) are being implemented using 5G communication technologies such as beamforming, multiple-input multiple-output (MIMO), and array antennas. It can be understood that the application of a cloud radio access network (RAN) as a big-data processing technology is an example of fusion of 5G technology and IoT technology. As such, a plurality of services can be provided to a user in a communication system, and in order to provide such a plurality of services to a user, a method of providing each service within the same time period according to characteristics and an apparatus using the same are required. Various services provided in 5G communication systems are being studied, and one of them is service that satisfies the requirements of low latency and high reliability.

In the case of vehicle communication, based on a device-to-device (D2D) communication structure, the LTE-based vehicle-to-everything (V2X) system has been standardized in 3GPP Rel-14 and Rel-15, and efforts to develop a V2X system based on 5G new radio (NR) are currently underway. In the NR V2X system, unicast communication, groupcast (or multicast) communication, and broadcast communication between terminals will be supported. In addition, NR V2X aims to provide more advanced services such as platooning, advanced driving, extended sensors, and remote driving, unlike LTE V2X, which aims merely to transmit and receive basic safety information necessary for vehicle driving on the road.

When a communication system operates at a high frequency, the possibility of failure to decode a received signal may increase due to phase noise. Accordingly, a phase-tracking reference signal (PTRS) can be transmitted and received as a reference signal for estimating phase noise. Here, it should be noted that the term “PTRS” may be replaced with another term. Generally, as the modulation order increases, the influence of phase noise at high frequencies increases. Therefore, the PTRS density varies in time depending on the modulation level that is used. When a high modulation degree is used, the PTRS density increases over time. In addition, the density of PTRS on frequency varies according to the number of scheduled resource blocks (RBs). In the NR Uu system, the greater the number of scheduled RBs, the higher the PTRS density on frequency. In addition, in the case of a multiple-input multiple-output (MIMO) system, one or more antenna ports are configured, and accordingly, when the number of transmission layers is greater than 1, phase-noise tracking may be required independently for each transmission layer. In other words, since different phase noise may be applied to each layer, it is necessary to estimate the phase noise using a PTRS divided for each layer. Similarly, even when multiple beams are transmitted, since different phase noises may be applied to each transmitted beam, it is necessary to track the phase noise by using the PTRS classified thereto. However, in a situation where PTRS is required, for example, a situation in which a high modulation rate and a large number of scheduled RBs are required, generating and transmitting a PTRS port for each MIMO layer or beam has a problem in that a very high PTRS overhead is incurred. Therefore, when a number of PTRS ports smaller than the number of MIMO layers or the number of beams is used, a method of associating the number of MIMO layers and/or the ports corresponding to the beams with the PTRS ports may be required.

In NR sidelink, subcarrier spacing may be supported according to the frequency range supported by the NR Uu system. [Table 1] and [Table 2] below show a part of the correspondence relationship between the system transmission bandwidth, subcarrier width and channel bandwidth in a frequency band lower than 6 GHz (frequency range 1) and a frequency band higher than 6 GHz (frequency range 2) in NR Uu, respectively. In the following [Table 1] and [Table 2], N/A may be a bandwidth-subcarrier combination that is not supported by the NR system. When a subchannel unit is defined in the sidelink, the size of the subchannel (sizeSubchannel) and the number of subchannels (numSubchannels) may be determined based on the width of the subcarrier and the number of RBs available in the channel bandwidth. For example, an NR system having a 100 MHz channel bandwidth with a 30 kHz subcarrier width may have a transmission bandwidth of 273 RBs. Therefore, in this case, when sizeSubchannel is configured with 10 RB, a numSubchannel value of up to 27 may be supported.

TABLE 1

| Channel | | | | | | | |
|---|---|---|---|---|---|---|---|
| bandwidth | | | | | | | |
| BW_{channel} | Subcarrier | 5 | 10 | 20 | 50 | 80 | 100 |
| [MHz] | width | MHz | MHz | MHz | MHz | MHz | MHz |
| Transmission | 15 kHz | 25 | 52 | 106 | 270 | N/A | N/A |
| bandwidth | 30 kHz | 11 | 24 | 51 | 133 | 217 | 273 |
| configuration | 60 kHz | N/A | 11 | 24 | 65 | 107 | 135 |
| N_{RB} | | | | | | | |

TABLE 2

| Channel bandwidth | Subcarrier | 50 | 100 | 200 | 400 |
|---|---|---|---|---|---|
| BW_{channel} [MHz] | width | MHz | MHz | MHz | MHz |
| Transmission | 60 kHz | 66 | 132 | 264 | N/A |
| bandwidth | 120 kHz | 32 | 66 | 132 | 264 |
| configuration N_{RB} | | | | | |

Accordingly, the NR sidelink may operate in a high-frequency region, and as described above, PTRS transmission may be required for phase noise estimation. At this time, a PTRS transmission and reception method that takes the sidelink transmission environment into consideration is required. Specifically, the terminal should be able to transmit and receive information using the sidelink with another terminal, both when connected to the base station (e.g., RRC connection state) and when not connected thereto (e.g., RRC connection release state, for example, RRC idle state). Therefore, as in the NR Uu system, when the PTRS transmission and reception configurations are made through RRC between the base station and the terminal, the terminal in a state in which the RRC connection between the base station and the terminal is released cannot obtain the transmission configuration information of the PTRS. Therefore, there is a need for a method of configuring suitable PTRS transmission and reception in the sidelink. The disclosure proposes various configuration methods therefor. In addition, a method of transmitting a PSSCH PTRS to a two-stage SCI is proposed when a two-stage SCI is supported in the sidelink. In addition, a method of multiplexing PTRS with other signals in the sidelink is proposed. Finally, when a number of PTRS ports smaller than the number of MIMO layers or the number of beams is used, a method of associating a port corresponding to the number of MIMO layers or beams and a PTRS port in the sidelink is proposed.

Hereinafter, embodiments for performing phase-noise tracking in the NR sidelink will be described in detail in the disclosure.

Various embodiments of the disclosure relate to a method and an apparatus for performing phase tracking in a process in which a vehicle terminal supporting V2X transmits and receives information using a sidelink with another vehicle terminal and/or a pedestrian portable terminal. In particular, when a communication system operates at a high frequency, decoding of a received signal may be erroneous due to phase noise. To this end, a phase-tracking reference signal (PTRS) may be transmitted and received to track phase noise in a sidelink signal. In the disclosure, a method of generating PTRS in a sidelink and transmitting and receiving the same is proposed. In addition, in the disclosure, operation of the base station and operation of the terminal according to various embodiments will be described in detail.

FIG. 1A illustrates an example of scenarios for sidelink communication in a wireless communication system according to various embodiments, FIG. 1B illustrates an example of scenarios for sidelink communication in a wireless communication system according to various embodiments, FIG. 1C illustrates an example of scenarios for sidelink communication in a wireless communication system according to various embodiments, and FIG. 1D illustrates an example of scenarios for sidelink communication in a wireless communication system according to various embodiments.

FIG. 1A illustrates an in-coverage (IC) scenario in which sidelink terminals 120 and 125 are located within the coverage 110 of the base station 100. The sidelink terminals 120 and 125 may receive data and control information from the base station 100 through downlink (DL), or may receive data and control information from the base station 100 through uplink (UL). In this case, the data and control information may be data and control information for sidelink (SL) communication or data and control information for general cellular communication other than sidelink communication. In addition, in FIG. 1A, the sidelink terminals 120 and 125 may transmit and receive data and control information for sidelink communication through the sidelink.

FIG. 1B illustrates a partial coverage (PC) scenario in which the first terminal 120 among the sidelink terminals is located within the coverage 110 of the base station 100 and the second terminal 125 is located outside the coverage 110 of the base station 100. The first terminal 120, located within the coverage 110 of the base station 100, may receive data and control information from the base station 100 through downlink or may transmit data and control information to the base station 100 through uplink. The second terminal 125, located outside the coverage of the base station 100, cannot receive data and control information from the base station 100 through downlink, and cannot transmit data and control information to the base station 100 through uplink. The second terminal 125 may transmit and receive data and control information for sidelink communication through the sidelink with the first terminal 120.

FIG. 1C illustrates an out-of-coverage (OOC) scenario in which sidelink terminals (e.g., the first terminal 120 and the second terminal 125) are located outside the coverage 110 of the base station 100. Accordingly, the first terminal 120 and the second terminal 125 cannot receive data or control information from the base station 100 through downlink, and cannot transmit data or control information to the base station 100 through uplink. The first terminal 120 and the second terminal 125 may transmit and receive data and control information for sidelink communication through a sidelink.

FIG. 1D illustrates an example of the case in which the first terminal 120 and the second terminal 125 performing sidelink communication perform inter-cell sidelink communication when they are connected to different base stations (e.g., the first base station 100 and the second base station 105) or are camping (e.g., RRC disconnection state, that is, RRC idle state) thereon. In this case, the first terminal 120 may be a sidelink transmission terminal, and the second terminal 125 may be a sidelink reception terminal. Alternatively, the first terminal 120 may be a sidelink reception terminal and the second terminal 125 may be a sidelink transmission terminal. The first terminal 120 may receive a sidelink-only system information block (SIB) from the first base station 100 to which the first terminal 120 is connected (or on which the first terminal 120 is camping), and the second terminal 125 may receive a sidelink-only SIB from another second base station 105 to which the second terminal 125 is connected (or on which the second terminal 125 is camping). In this case, the information of the sidelink-only SIB received by the first terminal 120 and the information of the sidelink-only SIB received by the second terminal 125 may be different from each other. Accordingly, in order to perform sidelink communication between terminals located in different cells, information may be unified, or an assumption and interpretation method thereof may additionally be required between cells.

In the examples of FIGS. 1A to 1D, for convenience of explanation, a sidelink system consisting of two terminals (e.g., a first terminal 120 and a second terminal 125) has been described as an example. However, the disclosure is not limited thereto, and may be applied to a sidelink system in which three or more terminals participate. In addition, the uplink and downlink between the base station 100 and the sidelink terminals 120 and 125 may be referred to as a Uu interface, and the sidelink between the sidelink terminals 120 and 125 may be referred to as a PC5 interface. In the following description, uplink or downlink and Uu interface, sidelink, and PC5 may be interchangeably used.

Meanwhile, in the disclosure, “terminal” may mean a vehicle supporting vehicle-to-vehicle (V2V) communication, a vehicle supporting vehicle-to-pedestrian (V2P) communication with a handset of a pedestrian (e.g., a smartphone), a vehicle supporting vehicle-to-network (V2N) communication, or a vehicle supporting vehicle-to-infrastructure (V2I) communication. In addition, in the disclosure, the terminal may mean a roadside unit (RSU) providing a terminal function, an RSU providing a base-station function, or an RSU providing part of a base-station function and part of a terminal function.

In addition, in the disclosure, the base station may be a base station supporting both V2X communication and general cellular communication, or may be a base station supporting only V2X communication. In this case, the base station may be a 5G base station (gNB), a 4G base station (eNB), or an RSU. Therefore, in the disclosure, the base station may be referred to as an RSU.

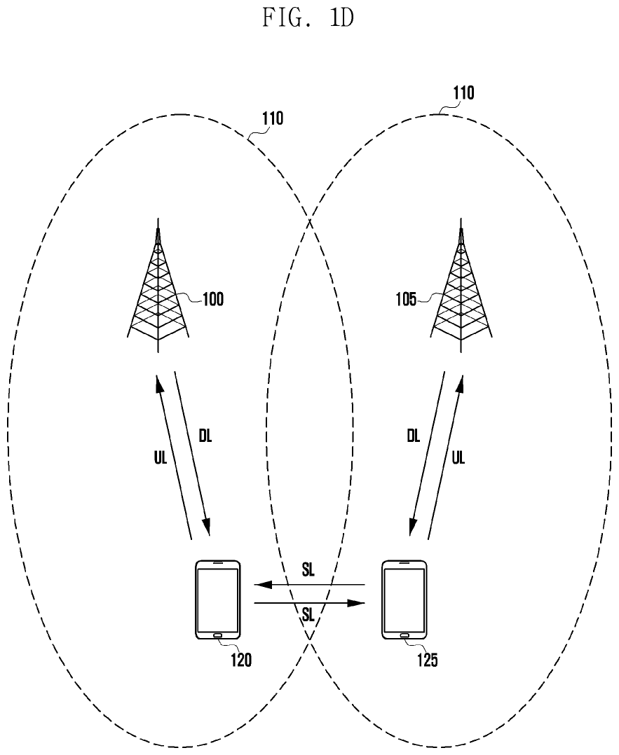

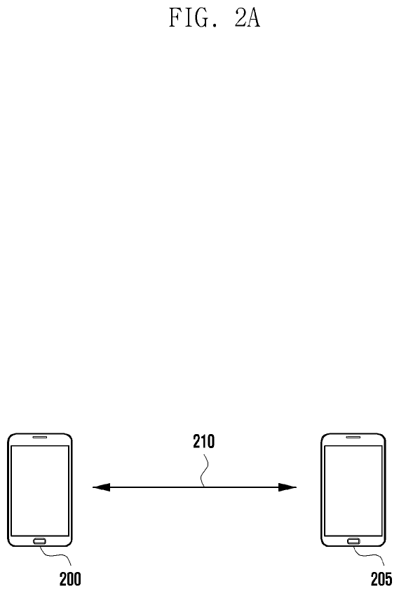

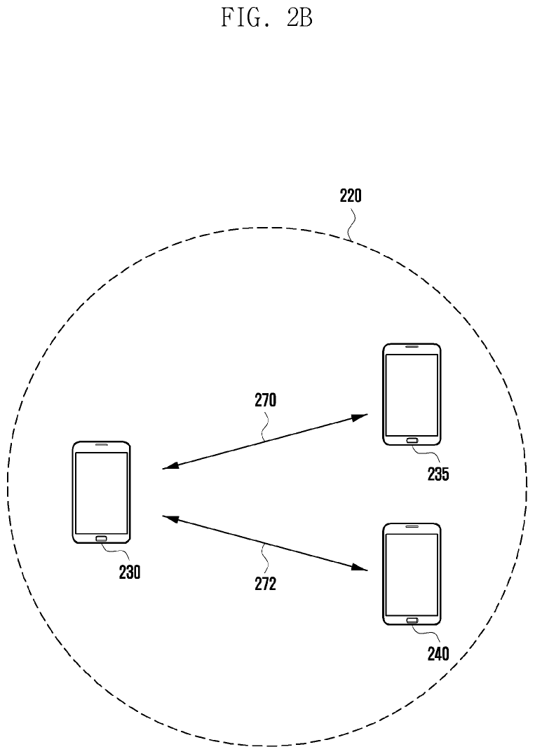

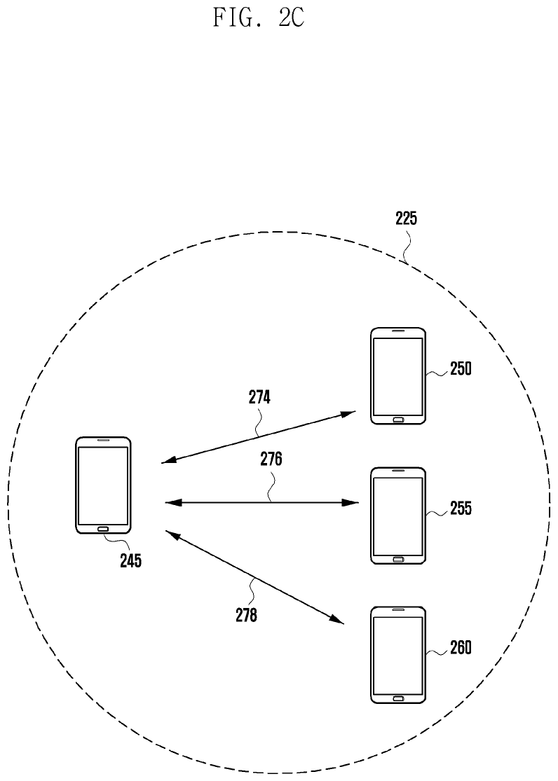

FIG. 2A illustrates an example of a transmission method of sidelink communication in a wireless communication system according to various embodiments, and FIGS. 2B-2C illustrate examples of a transmission method of sidelink communication in a wireless communication system according to various embodiments.

FIG. 2A illustrates a unicast method, and FIGS. 2B-2C illustrate groupcast methods.

As shown in FIG. 2A, a transmitting terminal 200 and a receiving terminal 205 may perform one-to-one communication. The transmission scheme shown in FIG. 2A may be referred to as unicast communication. As shown in FIG. 2B, a transmitting terminal 230 or 245 and receiving terminals 235, 240, 250, 255, and 260 may perform one-to-many communication. The transmission scheme shown in FIGS. 2B-2C may be referred to as groupcast or multicast transmission. In FIGS. 2B-2C, a first terminal 230, a second terminal 235, and a third terminal 240 form a group 220 and perform groupcast communication (270, and 272), while a fourth terminal 245, a fifth terminal 250, a sixth terminal 255, and a seventh terminal 260 may form a different group 225 and perform groupcast communication (274, 276, and 278). The terminals 230, 235, 240, 245, 250, 255, and 260 may perform groupcast communication within the groups 220 and 225 to which they belong, and may perform unicast, groupcast, or broadcast communication with at least one other terminal belonging to a different group. In FIGS. 2B-2C, two groups are illustrated, but the disclosure is not limited thereto, and may be applied even in the case in which a larger number of groups are formed.

Meanwhile, although not shown in FIG. 2A or 2B-2C, sidelink terminals may perform broadcast communication. “Broadcast communication” refers to a method in which all sidelink terminals receive data and control information transmitted by a sidelink transmission terminal through a sidelink. For example, in the case of broadcast communication, if the first terminal 230 in FIG. 2B is a transmitting terminal, the remaining terminals 235, 240, 245, 250, 255, and 260 may receive data and control information transmitted from the first terminal 230.

The aforementioned sidelink unicast communication, groupcast communication, and broadcast communication may be supported in an in-coverage scenario, a partial coverage scenario, or an out-of-coverage scenario.

In the case of NR sidelink, unlike LTE sidelink, support for a transmission type in which a vehicle terminal transmits data to only one specific terminal through unicast and a transmission type in which data is transmitted to a plurality of specific terminals through groupcast may be considered. For example, when considering a service scenario such as platooning, which is a technology in which two or more vehicles are connected through a single network and are grouped and move in a cluster form, such unicast and groupcast technologies can be usefully used. Specifically, unicast communication may be used for the purpose of controlling one specific terminal by a leader terminal of the group connected by platooning, and groupcast communication may be used for the purpose of simultaneously controlling a group consisting of a plurality of specific terminals.

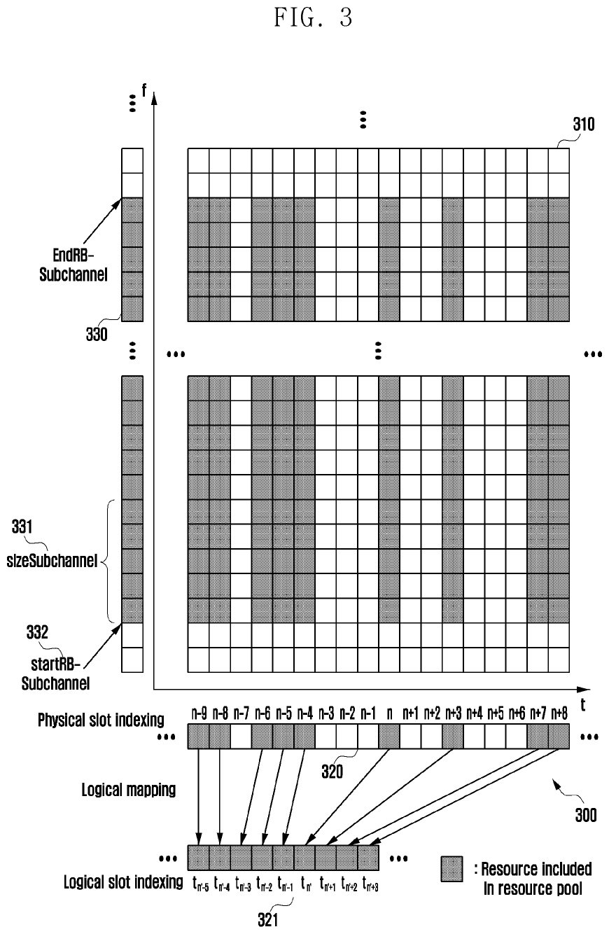

FIG. 3 illustrates an example of a sidelink resource pool in a wireless communication system according to various embodiments.

Referring to FIG. 3, a resource pool may be defined as a set of resources in a time and frequency domain used for transmission and reception of a sidelink.

In the resource pool, resource allocation granularity on the time axis may be one or more orthogonal frequency-division multiplexing (OFDM) symbols. In addition, the resource granularity of the frequency axis in the resource pool may be one or more physical resource blocks (PRBs).

When a resource pool is allocated in the time domain and the frequency domain, a region composed of shaded resources indicates a region configured as a resource pool in a time or frequency domain. In the disclosure, the case in which the resource pool is non-contiguously allocated in time will be described, but the disclosure is not limited thereto, and can also be applied when the resource pool is continuously allocated in time. In addition, although the case in which a resource pool is continuously allocated on a frequency domain will be described in the disclosure, the disclosure is not limited thereto, and can also be applied to the case where a resource pool is non-contiguously allocated in a frequency domain.

Referring to FIG. 3, the time domain 300 of the configured resource pool exemplifies the case in which resources are non-contiguously allocated in the time domain. In the time domain 300 of the resource pool, the granularity of resource allocation on the time axis may be a slot. Specifically, one slot composed of 14 OFDM symbols may be a basic granularity of resource allocation on the time axis. Referring to the time domain 300 of the configured resource pool, shaded slots represent slots allocated to the resource pool in time, and slots allocated to the resource pool in time may be indicated using system information. For example, slots allocated to the resource pool in time may be indicated to the terminal using the resource pool configuration information in time within the SIB. Specifically, at least one slot configured as a resource pool in time may be indicated through a bitmap. Referring to FIG. 3, physical slots 300 belonging to a non-contiguous resource pool on the time axis may be mapped to logical slots 325. In general, a set of slots belonging to a resource pool for a physical sidelink shared channel (PSSCH) may be expressed as (t0, t1, . . . , ti, . . . , tTmax).

Referring to FIG. 3, a frequency domain 305 of a configured resource pool exemplifies the case in which resources are continuously allocated in the frequency domain. In the frequency domain 305 of the resource pool, the granularity of resource allocation on the frequency axis may be a sub-channel 310. Specifically, one subchannel 310, composed of one or more resource blocks (RBs), may be defined as a basic granularity of resource allocation in a frequency domain. That is, the subchannel 310 may be defined as an integer multiple of RBs. Referring to FIG. 3, a subchannel size (sizeSubchannel) may be composed of five consecutive PRBs, but the disclosure is not limited thereto, and the size of the subchannel may be configured differently. In addition, although one sub-channel is generally composed of consecutive PRBs, the sub-channel is not necessarily composed of consecutive PRBs. The subchannel 310 may be a basic granularity of resource allocation for PSSCH. In addition, a subchannel for a physical sidelink feedback channel (PSFCH) may be defined independently of the PSSCH.

Referring to FIG. 3, the start position of a subchannel 310 in a frequency domain in a resource pool may be indicated by startRB-Subchannel 315. When resource allocation is performed in units of subchannels 310 on the frequency axis, resource pool configuration in the frequency domain may be performed through the RB index (startRB-Subchannel) 315 at which the subchannel 310 starts, information for indicating how many RBs the subchannel 310 is composed of (sizeSubchannel), and configuration information on the total number of subchannels 310 (numSubchannels). According to various embodiments, the subchannels allocated to a resource pool in a frequency domain may be indicated using system information. For example, at least one of startRB-Subchannel, sizeSubchannel, and numSubchannel may be indicated as frequency resource pool configuration information in the SIB. When the subchannel for the PSFCH is defined independently from the PSSCH, respective subchannel configuration information for the PSFCH and PSSCH may be indicated. In the disclosure, when the terminal is configured with related information as resource pool information, it may generally mean that the terminal is configured through system information (SIB) from the base station. However, for example, when the terminal does not receive system information from the base station, such as OOC, the resource-pool-related information may be preconfigured in the terminal (pre-configuration). Here, “preconfiguration” may refer to information previously stored and configured in the terminal, or may refer to information configured when the terminal previously accessed the base station. In addition, when the terminal receives the SIB from the base station and then receives resource pool information through RRC after RRC connection with the base station is established, the resource pool information configured through RRC may overwrite the information received through the SIB. In other words, resource pool information through RRC may be updated through RRC reconfiguration.

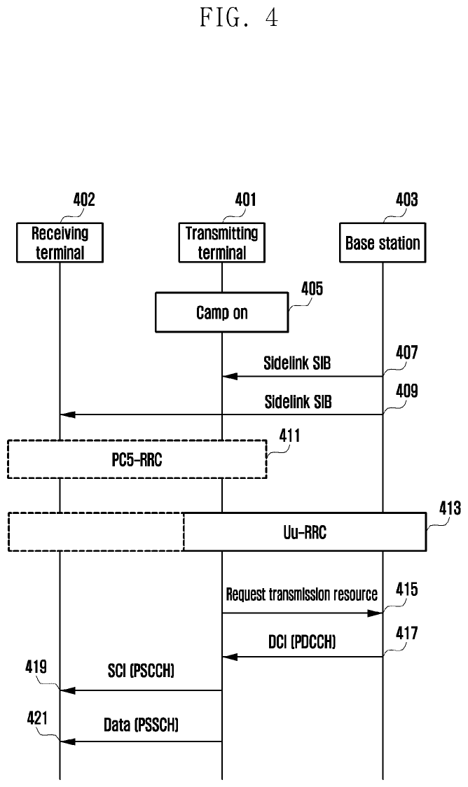

FIG. 4 illustrates an example of signal flow for allocating sidelink transmission resources in a wireless communication system according to various embodiments.

FIG. 4 exemplifies signal exchange between a transmitting terminal 401, a receiving terminal 402, and a base station 403.

As described below, a method in which the base station 403 allocates transmission resources for sidelink communication may be referred to as mode 1. Mode 1 is a scheme based on scheduled resource allocation by the base station 403. More specifically, in mode 1 resource allocation, the base station 403 may allocate a resource used for sidelink transmission to the RRC-connected terminals 401 and 402 according to a dedicated scheduling scheme. Since the base station 403 can manage the resources of the sidelink, scheduled resource allocation is advantageous for interference management and resource pool management (e.g., dynamic allocation and/or semi-persistent transmission).

Referring to FIG. 4, the transmitting terminal 401 camp on as in step 405 may receive a sidelink SIB from the base station 403 in step 407. In step 409, the receiving terminal 402 may receive a sidelink system information block (SIB) from the base station 403. Accordingly, the receiving terminal 502 may also be a terminal camping on the base station 503. Here, the receiving terminal 402 is a terminal that receives data transmitted by the transmitting terminal 401. The sidelink SIB may be transmitted periodically or when requested by the terminal. In addition, the sidelink SIB may include at least one of sidelink resource pool information for sidelink communication, parameter configuration information for a sensing operation, information for configuring sidelink synchronization, or carrier information for sidelink communication operating at different frequencies. Steps 407 and 409 have been described as being performed sequentially above, but this is for convenience of description, and steps 407 and 409 may be performed in parallel.

In step 413, when data traffic for sidelink communication is generated in the transmitting terminal 401, the transmitting terminal 401 may be RRC-connected with the base station 403. Here, the RRC connection between the transmitting terminal 401 and the base station 403 may be referred to as Uu-RRC. The Uu-RRC connection may be performed before the transmission terminal 401 generates data traffic. In addition, in the case of mode 1, in a state in which a Uu-RRC connection is established between the base station 403 and the receiving terminal 402, the transmitting terminal 401 may perform transmission to the receiving terminal 402 through a sidelink. In addition, in the case of mode 1, the transmitting terminal 401 may perform transmission to the receiving terminal 402 through a sidelink even when the Uu-RRC connection is not established between the base station 403 and the receiving terminal 402.

In step 415, the transmitting terminal 401 may request a transmission resource for performing sidelink communication with the receiving terminal 402 from the base station 403. At this time, the transmitting terminal 401 may request transmission resources for the sidelink using at least one of an uplink physical uplink control channel (PUCCH), an RRC message, or a media access control (MAC) control element (CE) from the base station 403. For example, when MAC CE is used, the MAC CE may be MAC CE for a buffer status report (BSR) having a new format including at least one of an indicator for indicating that the buffer status report is for sidelink communication and information on the size of data buffered for device-to-device (D2D) communication. In addition, when PUCCH is used, the transmitting terminal 401 may request a sidelink resource through a bit of a scheduling request (SR) transmitted through an uplink physical control channel.

In step 417, the base station 403 may transmit downlink control information (DCI) to the transmitting terminal 401 through PDCCH. That is, the base station 403 may indicate the transmitting terminal 401 to perform final scheduling for sidelink communication with the receiving terminal 402. More specifically, the base station 403 may allocate sidelink transmission resources to the transmitting terminal 401 according to at least one of a dynamic grant scheme or a configured grant (CG) scheme.

In the case of the dynamic grant scheme, the base station 403 transmits the DCI to the transmitting terminal 401 to allocate resources for transmission of one transport block (TB). The sidelink scheduling information included in the DCI may include a parameter related to an initial transmission time and/or a retransmission time and a parameter related to a frequency allocation location information field. DCI for the dynamic grant scheme may be scrambled with a cyclic redundancy check (CRC) based on a sidelink-v2x-radio network temporary identifier (SL-V-RNTI) to indicate that the transmission resource allocation scheme is a dynamic grant scheme.

In the case of the configured grant scheme, by configuring a semi-persistent scheduling (SPS) interval in Uu-RRC, resources for transmitting a plurality of TBs may be periodically allocated. In this case, the base station 403 may allocate resources for a plurality of TBs by transmitting the DCI to the transmitting terminal 401. The sidelink scheduling information included in the DCI may include a parameter related to an initial transmission time and/or a retransmission time and a parameter related to a frequency allocation location information field. In the case of the configured grant scheme, an initial transmission time (occasion) and/or a retransmission time and a frequency allocation position may be determined according to the transmitted DCI, and the resource may be repeated at SPS intervals. The DCI for the configured grant scheme may be a CRC scrambled based on the SL-SPS-V-RNTI to indicate that the transmission resource allocation scheme is the configured grant scheme. In addition, the configured grant method may be classified into a type 1 CG and a type 2 CG. In the case of a type 2 CG, the base station 403 may activate and/or deactivate a resource configured by a configured grant through DCI. Accordingly, in the case of mode 1, the base station 403 may indicate the transmitting terminal 401 to final scheduling for sidelink communication with the receiving terminal 402 by transmitting the DCI through the PDCCH.

When broadcast transmission is performed between the terminals 401 and 402, in step 419, the transmitting terminal 401 may broadcast sidelink control information (SCI) to the receiving terminal 402 through PSCCH without additional sidelink RRC configuration (step 411). Further, in step 421, the transmitting terminal 401 may broadcast data to the receiving terminal 402 through the PSSCH.

When unicast or groupcast transmission is performed between the terminals 401 and 402, in step 411, the transmitting terminal 401 may perform a one-to-one RRC connection with other terminals (e.g., the receiving terminal 402). In this case, in order to distinguish the same from Uu-RRC, the RRC connection between the terminals 401 and 402 may be referred to as PC5-RRC. In the case of the groupcast transmission scheme, the PC5-RRC connection may be individually established between the terminals in the group. Referring to FIG. 4, although the connection of the PC5-RRC (step 411) is shown as an operation after the transmission of the sidelink SIB (steps 407 and 409), the connection of the PC5-RRC (step 411) may be performed before the transmission of the sidelink SIB or before the broadcast of the SCI (step 419). When RRC connection between the terminals is required, the PC5-RRC connection of the sidelink is performed, and in step 419, the transmitting terminal 401 may transmit the SCI to the receiving terminal 402 through the PSCCH via unicast or groupcast. At this time, the groupcast transmission of SCI may be understood as a group SCI. In addition, in step 421, the transmitting terminal 401 may transmit data to the receiving terminal 402 through the PSSCH through unicast or groupcast. In the case of mode 1, the transmitting terminal 401 may identify sidelink scheduling information included in the DCI received from the base station 403, and may perform sidelink scheduling based on the sidelink scheduling information. The SCI may include the following scheduling information.
Fields related to transmission time and frequency allocation location information of initial transmission and retransmission
New data indicator (NDI) field
Redundancy version (RV) field
Information field to indicate reservation interval

The information field for indicating the reservation interval may be indicated as a value in which the interval between TBs is fixed when resources for a plurality of TBs (i.e., a plurality of media access control (MAC) protocol data units (PDUs)) are selected, and when a resource for one TB is selected, ‘0’ may be indicated as the value of the interval between TBs.

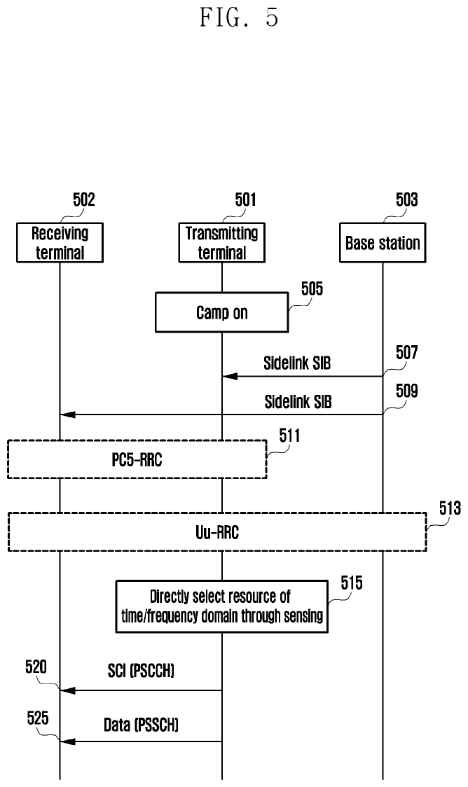

FIG. 5 illustrates another example of signal flow for allocating sidelink transmission resources in a wireless communication system according to various embodiments.

FIG. 5 exemplifies signal exchange between a transmitting terminal 501, a receiving terminal 502, and a base station 503.

As described below, a method in which the terminal 501 directly allocates sidelink transmission resources through sensing in the sidelink may be referred to as mode 2. Mode 2 may also be referred to as UE autonomous resource selection. Specifically, according to mode 2, the base station 503 may transmit a pool of sidelink transmission/reception resources for the sidelink to the terminals 501 and 502 as system information or an RRC message (e.g., an RRC reconfiguration message, a PC5 RRC message), and the transmitting terminal 501 may select a resource pool and a resource according to a predetermined rule. Unlike mode 1, in which the base station 503 is directly involved in resource allocation, mode 2, described in FIG. 5, may autonomously select a resource and transmit data, based on a resource pool previously received by the transmitting terminal 501 through system information.

Referring to FIG. 5, the transmitting terminal 501 camp on as in step 505 may receive a sidelink SIB from the base station 503 in step 507. In step 509, the receiving terminal 502 may receive a sidelink SIB from the base station 503. Accordingly, the receiving terminal 502 may also be a terminal camping on the base station 503. Here, the receiving terminal 502 refers to a terminal that receives data transmitted by the transmitting terminal 501. The sidelink SIB may be transmitted periodically or when requested by the terminal. In addition, the sidelink SIB information may include at least one of sidelink resource pool information for sidelink communication, parameter configuration information for a sensing operation, information for configuring sidelink synchronization, or carrier information for sidelink communication operating at different frequencies. Steps 507 and 509 have been described as being performed sequentially above, but this is for convenience of description, and steps 507 and 509 may be performed in parallel.

In the case of FIG. 4 described above, the base station 503 and the transmitting terminal 501 operate in a state in which the RRC is connected, whereas in FIG. 5, the base station 503 and the transmitting terminal 501 may operate regardless of whether RRC between the base station 503 and the transmitting terminal 501 is connected in step 513. For example, the base station 503 and the transmitting terminal 501 may operate in an idle mode 513 in which RRC is not connected. In addition, even in a state in which RRC is connected, the base station 503 may operate so that the transmitting terminal 501 autonomously selects a transmission resource without being directly involved in resource allocation. In this case, the RRC connection between the transmitting terminal 501 and the base station 503 may be referred to as Uu-RRC.

In step 515, when data traffic for sidelink communication is generated by the transmitting terminal 501, the transmitting terminal 501 may be configured with a resource pool through system information received from the base station 503, and may directly select time- and frequency-domain resources through sensing within the configured resource pool.

When broadcast transmission is performed between the terminals 501 and 502, in step 520, the transmitting terminal 501 may broadcast the SCI to the receiving terminal 502 through the PSCCH without additional sidelink RRC configuration (step 513). Further, in step 525, the transmitting terminal 501 may broadcast data to the receiving terminal 502 through the PSSCH.

When unicast transmission and groupcast transmission are performed between the terminals 501 and 502, the transmitting terminal 501 may establish a one-to-one RRC connection with other terminals (e.g., the receiving terminal 502) in step 511. In this case, the RRC connection between the terminals 501 and 502 may be referred to as PC5-RRC in order to distinguish that RRC connection from Uu-RRC. In the case of the groupcast transmission method, PC5-RRC connection is individually established between terminals in the group. In FIG. 5, the PC5-RRC connection (step 511) is shown as an operation after transmission of the sidelink SIB (step 507, step 509), but may be performed before transmission of the sidelink SIB or before transmission of the SCI (step 519). If the RRC connection between the terminals is required, the PC5-RRC connection of the sidelink may be performed, and in step 520, the transmitting terminal 501 may transmit the SCI to the receiving terminal 502 through the PSCCH by unicast or groupcast. At this time, groupcast transmission of SCI may be understood as group SCI. In addition, in step 525, the transmitting terminal 501 may transmit data to the receiving terminal 502 through the PSSCH through unicast or groupcast. In the case of mode 2, the transmitting terminal 501 may directly perform sidelink scheduling by performing sensing and transmission resource selection operations. The SCI may include the following scheduling information.
Fields related to transmission time and frequency allocation location information of initial transmission and retransmission
New data indicator (NDI) field
Redundancy version (RV) field
Information field for indicating reservation interval

The information field for indicating the reservation interval may be indicated as one value in which an interval between TBs is fixed when a resource for a plurality of TBs (i.e., a plurality of MAC PDUs) is selected, and when a resource for one TB is selected, ‘0’ may be indicated as the value of an interval between TBs.

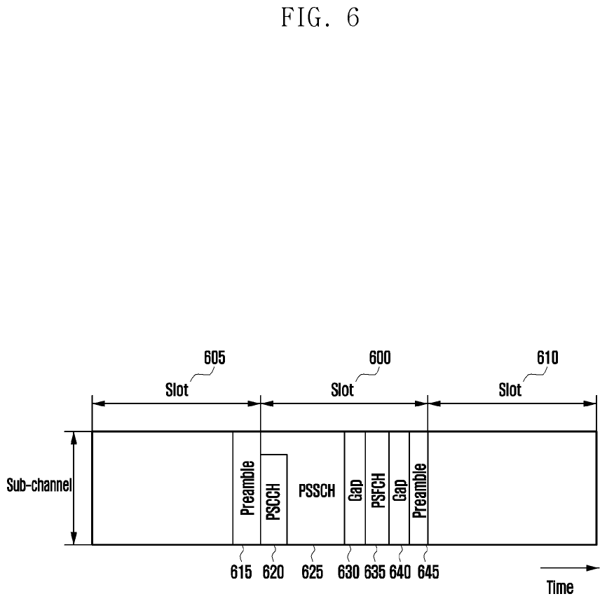

FIG. 6 illustrates an example of a channel structure of a slot used for sidelink communication in a wireless communication system according to various embodiments.

Referring to FIG. 6, a preamble 615 is mapped before the start of the slot 600, that is, to the rear end of the previous slot 605. Thereafter, from the start of the slot 600, a PSCCH 620, a PSSCH 625, a gap 630, a PSFCH 635, and a gap 640 are mapped.

Before transmitting the signal in the corresponding slot 600, the transmitting terminal may transmit the preamble 615 in one or more symbols. The preamble 615 may be used to enable the receiving terminal to correctly perform automatic gain control (AGC) for adjusting the intensity of amplification when amplifying the power of the received signal. In addition, the preamble 615 may or may not be transmitted depending on whether the transmission terminal transmits the previous slot 605. That is, when the transmitting terminal transmits a signal to the same terminal in a slot (e.g., slot 605) preceding the corresponding slot (e.g., slot 600), transmission of the preamble 615 may be omitted. The preamble 615 may be referred to as a ‘sync signal’, a ‘sidelink sync signal’, a ‘sidelink reference signal’, a ‘midamble’, an ‘initial signal’, a ‘wake-up signal’, or using another term having an equivalent technical meaning.

The PSCCH 620 including control information may be transmitted using symbols transmitted at the beginning of the slot 600, and the PSSCH 625 scheduled by the control information of the PSCCH 620 may be transmitted. At least a part of SCI, which is control information, may be mapped to the PSSCH 625. Thereafter, a gap 630 exists, and a PSFCH 635, which is a physical channel for transmitting feedback information, may be mapped.

In the case of FIG. 6, the PSFCH 635 is illustrated as being located at the last part of the slot. A terminal that has transmitted or received the PSSCH 625 may prepare (e.g., transmission/reception switching) to transmit or receive the PSFCH 635 by securing a gap 630, which is an empty time for a predetermined period of time between the PSSCH 625 and the PSFCH 635. After the PSFCH 635, a gap 640, which is an empty period for a predetermined time, may exist.

The terminal may receive the position of a slot capable of transmitting the PSFCH 635 in advance. Receiving the position of a slot in advance means that the position of a slot can be determined in advance during the process of creating the terminal, or can be transmitted to the terminal when the terminal accesses a system related to sidelink, or can be transmitted from the base station to the terminal when the terminal accesses the base station, or that the terminal can receive the same from another terminal.

In the embodiment of FIG. 6, it has been described that a preamble signal for performing AGC is separately transmitted in a physical channel structure in a sidelink slot. However, according to another embodiment, a separate preamble signal is not transmitted, and while receiving control information or a physical channel for data transmission, it is possible for the receiver of the receiving terminal to perform an AGC operation using a control degree or a physical channel for data transmission.

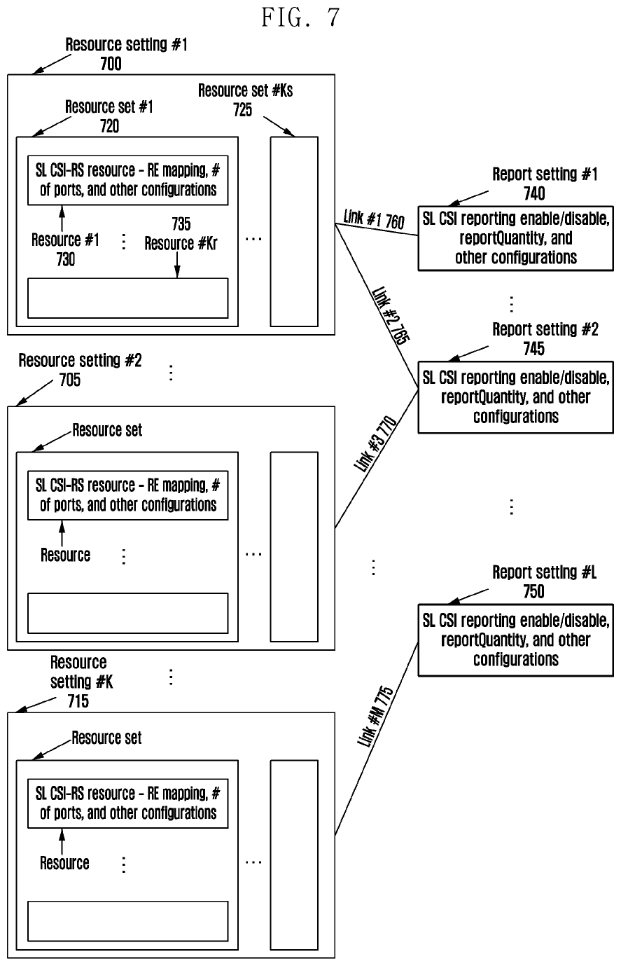

FIG. 7 illustrates a diagram illustrating a channel-state information framework of an NR sidelink system according to an embodiment.

The channel status information (CSI) framework of FIG. 7 may be composed of two elements of resource setting and report setting. The report setting may configure at least one or more links by referring to the ID of the resource setting.

According to an embodiment, the resource settings 700, 705, and 715 may include information related to a reference signal (RS). At least one resource setting 700, 705, or 715 may be configured in the receiving terminal. Each resource setting 700, 705, or 715 may include at least one resource set 720 or 725. Each resource set 720 or 725 may include at least one resource 730 or 735. Each resource 730 or 735 may include detailed information about the RS, for example, transmission band information through which RS is transmitted (e.g., a sidelink bandwidth part (SL BWP)), position information of a resource element (RE) through which RS is transmitted, an RS transmission period and offset on the time axis, a number of an RS port, and the like. As described above, the corresponding RS may be referred to as SL CSI-RS, and when periodic SL CSI-RS is not supported, the RS transmission period and offset information on the time axis may not be included. In addition, the resource 730 or 735 may include a PTRS port index associated with the SL CSI-RS.

According to an embodiment, the report settings 740, 745, and 750 may include information related to the SL CSI reporting method. The base station may configure at least one report setting 740, 745, or 750 in the terminal. At this time, configuration information to enable/disable SL CSI reporting, configuration information to enable/disable channel-busy-ratio (CBR) reporting, the type of channel through which the report is transmitted (e.g., PSSCH or physical sidelink feedback channel (PSFCH), etc.), information on the band in which SL CSI is reported (e.g., SL BWP), configuration information for a codebook when a precoding matrix indicator (PMI) is supported, time-domain behavior for SL CSI reporting, frequency granularity for SL CSI reporting, configuration information for measurement restriction, effective SL CSI window configuration information, and reportQuantity, which is information included in SL CSI, may be included in the parameter information of SL-CSI-ReportConfig, and may be included in each report setting 740, 745, or 750. Specifically, the time-domain behavior for the SL CSI report may be information on whether the SL CSI report is periodic or aperiodic. In the disclosure, the case where the SL CSI report is configured aperiodically is considered. Also, the frequency granularity for the SL CSI report means a unit of frequency for the SL CSI report.

In the disclosure, in consideration of a sidelink transmission environment, unlike a Uu interface between a base station and a terminal, a non-subband-based aperiodic SL CSI report may be transmitted through a PSSCH or PSFCH only for a frequency domain corresponding to a corresponding PSSCH.

The configuration information for the measurement restriction means configuration as to whether or not the measurement section is restricted with regard to time or frequency for channel measurement when measuring a channel.

The effective SL CSI window configuration information is information for determining that the SL CSI is not valid when the SL CSI window is exceeded in consideration of the CSI feedback delay. Details will be described later.

Finally, reportQuantity indicates information included in SL CSI, and in the disclosure, configuration of a channel quality indicator (CQI), a channel quality indicator/rank indicator (CQI-RI), or a CQI-RI-PMI is considered. In addition, reportQuantity may include CBR information of the receiving terminal. In this case, the report setting may include at least one ID (the ID of the resource setting (700, 705, 715)) for referring to a channel referenced by the terminal during CSI reporting or reference signal information (and/or RE position) for interference measurement. Through this method, the resource configuration (700, 705, 715) and the report setting (740, 745, 750) can be linked, and, for example, may be schematically illustrated as the link (760, 765, 770, 775) of FIG. 7. However, embodiments of the disclosure are not limited thereto. For example, a method of linking by including the ID of at least one resource setting (700, 705, 715) and the ID of the report setting (740, 745, 750) in one measurement setting (mea-Config) is also possible.

According to an embodiment of the disclosure, when one reporting setting 740 and one resource setting 700 are connected according to the link 760, the resource setting 700 may be used for channel measurement. In addition, the receiving terminal may report the CSI using the information included in the reporting setting 740.

According to an embodiment of the disclosure, when connecting one reporting setting 745 and two resource settings 700 and 705 according to the link 765 or 770, one of the two resource settings 700 and 705 may be used for channel measurement, and the remaining resource setting 700 or 705 may be used for interference measurement.

In addition, according to an embodiment of the disclosure, resource settings 700, 705, and 715 and report settings 740, 745, and 750 may be connected to the resource pool and may be (pre-)configured for each resource pool. Information configured for each resource pool may be indicated through SL-SIB or UE-specific higher-layer signaling. When indicated through SL-SIB, a corresponding value may be configured in the resource pool information among corresponding system information. Even if the corresponding value is configured through an upper layer, the corresponding value may be configured to be UE-specific through Uu-RRC or PC5-RRC as information in the resource pool. In addition, the configuration method for the resource settings 700, 705, and 715 and the report settings 740, 745, and 750 may be different depending on whether the terminal is in an IC/PC/OCC environment or a transmission resource allocation mode (mode 1/2) in the sidelink. As described above, each resource setting 700, 705, or 715 in the channel-state information framework of the NR sidelink system may include at least one resource set 720 or 725, and each resource set 720 or 725 may include at least one resource 730 or 735. Hereinafter, when detailed information on the SL CSI-RS is configured in each resource settings 700, 705, and 715, the condition and method in which the actual SL CSI-RS is transmitted will be described. Prior to this, in the case of the Uu interface between the base station and the terminal, the CSI-RS is transmitted over the entire band of the configured frequency. In addition, the terminal feeds back the CSI report for all frequency bands in wideband or sub-band form, so that the base station may receive the CSI report for the entire frequency band. However, considering that the sidelink of V2X is communication between terminals, SL CSI-RS transmission may be limited to the transmission region of the PSSCH and transmitted. In other words, the SL CSI-RS together with the PSSCH may be transmitted only in a frequency domain in which resources are allocated to the PSSCH.

When a communication system operates at a high frequency, the possibility of failure to decode a received signal may increase due to phase noise.

The disclosure relates to performing phase tracking in the sidelink of V2X, and relates to a method and apparatus for transmitting and receiving a phase-tracking reference signal (PTRS) in a V2X sidelink. In the disclosure, a method and an apparatus for generating and transmitting and receiving PTRS in a sidelink are proposed. This is a method to reduce the probability of failure to decode a received signal due to phase noise when the sidelink operates at a high frequency.

A method of operating a terminal for performing phase tracking in an NR sidelink will be described in detail through the following specific embodiments.

### First Embodiment

In the first embodiment of the disclosure, a method of configuring PTRS-related parameters in a sidelink will be described. The configured PTRS-related parameter information must be understood by both the transmitting terminal transmitting the signal in the sidelink and the receiving terminal receiving the signal. One or more of the following parameters may be considered as PTRS-related parameter information. However, the disclosure is not limited to the following PTRS-related parameters.

[Parameters Related to PTRS in Sidelink]

PTRS ON/OFF:
If the configuration is ‘ON’ in the sidelink, the configuration is interpreted that the PTRS is ‘present’ and the PTRS can be transmitted. However, even if the configuration is configured as ‘ON’, PTRS may not be transmitted due to additional conditions. If the configuration is configured as ‘OFF’, the configuration may be interpreted that PTRS is not ‘present’, and PTRS may not be transmitted.

PTRS Time Density:
Means the density value in time (L_{PT-RS}) for the PTRS pattern of the sidelink. For example, the density may be in units of OFDM symbols. L_{PT-RS} may be a fixed value, and may be configured as {0, 1, 2, 4}. In this case, ‘0’ may indicate that no PTRS is transmitted, and 1, 2, and 4 may indicate that the PTRS is transmitted every 1, 2, and 4 OFDM symbols in time. Alternatively, L_{PT-RS} may be determined by a configured MCS range value. For example, as shown in Table 3 below, ptrs-MCS1, ptrs-MCS2, ptrs-MCS3, and ptrs-MCS4, which are MCS range values, may be configured, and L_{PT-RS} may be determined by the scheduled MCS. The ptrs-MCS4 may not be configured and determined as the maximum MCS value in the MCS table used for the sidelink. For example, according to the following [Table 3], PTRS is not transmitted when the scheduled MCS is 3 when ptrs-MCS1=5 and ptrs-MCS2=10 are configured, and when the scheduled MCS is 7 PTRS, PTRS may be transmitted every OFDM symbol. The disclosure is not limited as to the method of indicating/setting the temporal density value (L_{PT-RS}) for the PTRS pattern described above. The method of indicating/setting the temporal density value for the PTRS pattern described above is an example for understanding the disclosure, and a more limited L_{PT-RS} value may be used in addition to the method illustrated in the disclosure. In addition, a temporal density value (L_{PT-RS}) for various PTRS patterns may be used based on the method described above.

PTRS Frequency Density:
Means the frequency density value (K_{PT-RS}) for the PTRS pattern of the sidelink. For example, the density may be in RB units in terms of frequency. K_{PT-RS} may be a fixed value, and can be configured as {0, 2, 4}. In this case, ‘0’ indicates that the frequency density is 0, indicating that no PTRS is transmitted. Specifically, this indicates that the PTRS is not transmitted through frequency repetition. In addition, 2 and 4 may mean that the PTRS is repeatedly transmitted every 2 and 4 RBs on the frequency. Alternatively, K_{PT-RS} may be determined by a configured frequency range value. For example, as shown in [Table 4] below, the frequency range value is configured as the number of RBs, such as NRB0 and NRB1, and the PTRS frequency density may be determined by the scheduled number of RBs. For example, according to the following [Table 4], PTRS may not be transmitted when the number of scheduled RBs is 2 in the case that NRB0 is configured as 4 and NRB1 is configured as 10, PTRS may be transmitted every 4 RBs on a frequency, when the number of scheduled RBs is 20. As another example, as shown in Table 5 below, a frequency range value is configured as the number of subchannels, such as NSubCH0 and NSubCH1, and K_{PT-RS} may be determined by the number of scheduled subchannels. Since a detailed description of the sub-channel has already been made in connection in FIG. 3, a detailed description will be omitted here. For example, according to [Table 5], PTRS may not be transmitted when the number of scheduled subchannels is 1 when NSubCH0 is configured as 2 and NSubCH1 is configured as 5, and when the number of scheduled subchannels is 4, PTRS may be transmitted every 2 RBs on a frequency. The disclosure is not limited to the method of indicating/setting the frequency density value (K_{PT-RS}) for the PTRS pattern described above. The method for indicating/configuring the temporal density value for the PTRS pattern described above is an example for understanding the disclosure, and a more limited K_{PT-RS} value may be used in addition to the method illustrated in the disclosure. In addition, a frequency image density value (K_{PT-RS}) for various PTRS patterns may be used based on the method described above.

PTRS Port-Related Information:
The maximum number of PTRS ports in the sidelink may be configured. When the corresponding information is indicated by the base station, the terminal cannot transmit a number of PTRS greater than the configured maximum number of PTRS ports. In addition, connection information between the PTRS port and the DMRS port may be configured. In general, the number of supported PTRS ports may be smaller than the number of DMRS ports due to PTRS overhead. In this case, a PTRS port connected thereto may be used to track the phase noise generated in the DMRS port.

PTRS Power-Scaling Information:
PTRS power-scaling information may be configured. PTRS power scaling can be applied in consideration of the number of PTRS ports so that the power of a symbol to which PTRS is transmitted and a symbol to which PTRS is not transmitted are kept constant. For example, the following [Table 6] shows PTRS power-scaling values supported according to a codebook that is applied when up to two PTRS ports (Qp) are supported. The codebook in Table 4 described above is assumed to be a UL codebook in the Uu system. The UL codebook in the Uu system may be reused in the sidelink. Also, codebook-based transmission and non-codebook-based transmission may be used in the sidelink. In the case of codebook-based transmission, a codebook may be applied to PSSCH transmission and transmitted, and the codebook may be classified into a fully coherent, partially coherent, or non-coherent codebook. In addition, in the case of non-codebook transmission, the codebook is not applied to PSSCH transmission. In [Table 6] below, PTRS power-scaling values applied according to the number of PSSCH transmission layers and applied transmission methods (codebook or non-codebook) are presented.

PTRS Resource Element Offset Information:
PTRS resource element offset information (resourceElementOffset) may be configured to configure the position at which PTRS is transmitted. For example, in [Table 7], a reference RE location (k_{ref}^{RE}) at which PTRS is transmitted for a DMRS antenna port according to a demodulation reference signal (DMRS) configuration type 1 and a DMRS configuration type 2 is shown. According to the configured resourceElementOffset value, the position of the RE on the frequency at which the PTRS in the RB is transmitted may be determined. The PTRS transmission location can be randomized by changing the corresponding value. For example, when a corresponding configuration is configured for each resource pool, there may be an effect of randomizing the effect of PTRS interference between resource pools.

TABLE 3

| Scheduled MCS | Time density (L_{PT-RS}) |
|---|---|
| I_{MCS} < ptrs-MCS1 | PT-RS is not present |
| ptrs-MCS1 < I_{MCS} < ptrs-MCS2 | 4 |
| ptrs-MCS2 < I_{MCS} < ptrs-MCS3 | 2 |
| ptrs-MCS3 < I_{MCS} < ptrs-MCS4 | 1 |

TABLE 4

| Scheduled bandwidth | Frequency density (K_{PT-RS}) |
|---|---|
| N_{RB} < N_{RB0} | PT-RS is not present |
| N_{RB0} ≤ N_{RB} < N_{RB1} | 2 |
| N_{RB1} ≤ N_{RB} | 4 |

TABLE 5

| Scheduled bandwidth | Frequency density (KPT-RS) |
|---|---|
| N_{SubCH} < N_{SubCH0} | PT-RS is not present |
| N_{SubCH0} ≤ N_{SubCH} < N_{SubCH1} | 2 |
| N_{SubCH1} ≤ N_{SubCH} | 4 |

TABLE 6

| | The number of PSSCH layers (n_{layer}^{PSSCH}) | | | | | | | |
|---|---|---|---|---|---|---|---|---|
| | | 2 | | 3 | | | | |
| | | | Partial and | | Partial and | 4 | | |
| | | | non- | | non- | | | Non- |
| SL- | | | coherent | | coherent | | | coherent |
| PTRS- | 1 | | and non- | | and non- | | | and non- |
| power/ | All | Full | codebook | Full | codebook | Full | Partial | codebook |
| α_{PTRS}^{PSSCH} | cases | coherent | based | coherent | based | coherent | coherent | based |
| 00 | 0 | 3 | 3Qₚ−3 | 4.77 | 3Qₚ−3 | 6 | 3Qₚ | 3Qₚ−3 |
| 01 | 0 | 3 | 3 | 4.77 | 4.77 | 6 | 6 | 6 |

| | |
|---|---|
| 10 | Reserved |
| 11 | Reserved |

TABLE 7

| | k_{ref}^{RE} | | | | | | | |
|---|---|---|---|---|---|---|---|---|
| | DM-RS | | | | DM-RS | | | |
| DM-RS | Configuration type 1 | | | | Configuration type 2 | | | |
| antenna | resourceElementOffset | | | | resourceElementOffset | | | |
| port | 00 | 01 | 10 | 11 | 00 | 01 | 10 | 11 |
| 0 | 0 | 2 | 6 | 8 | 0 | 1 | 6 | 7 |
| 1 | 2 | 4 | 8 | 10 | 1 | 6 | 7 | 0 |
| 2 | 1 | 3 | 7 | 9 | 2 | 3 | 8 | 9 |
| 3 | 3 | 5 | 9 | 11 | 3 | 8 | 9 | 2 |
| 4 | — | — | — | — | 4 | 5 | 10 | 11 |
| 5 | — | — | — | — | 5 | 10 | 11 | 4 |

Next, a method in which PTRS-related parameters can be configured in the above-described sidelink will be described. In addition, PTRS transmission and reception procedures according to the configuration method are described. In the disclosure, the method of configuring PTRS-related information in the following sidelink is not limited. In addition, PTRS-related information may be configured by a combination of the configuration methods described below.

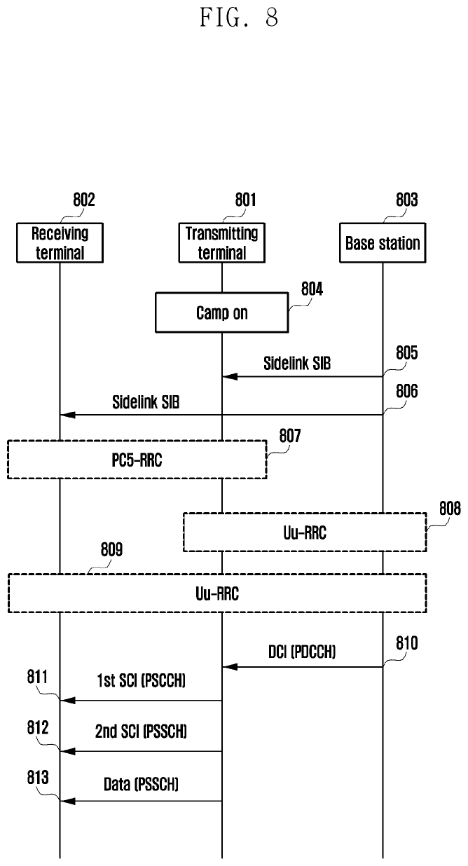

FIG. 8 illustrates a diagram for explaining a PTRS transmission and reception procedure in a sidelink according to an embodiment.

As described above with reference to FIGS. 4 and 5, the order of each step in FIG. 8 may be changed. For example, the order in which Uu-RRC and PC5-RRC are connected may be different from the order shown in FIG. 8.

[PTRS-Related Information Setting Method and Transmission/Reception Procedure in Sidelink]

Method 1: Use a Fixed Value:
This method is a method in which all terminals of the sidelink transmit and receive PTRS using the fixed values by fixing the setting values for the PTRS-related parameters. Therefore, it is not necessary to configure the value, but it must be decided what value to fix. In addition, both the transmitting terminal 801 that transmits a signal on the sidelink and the receiving terminal 802 that receives the same can transmit and receive PTRS on the assumption of fixed (promised) PTRS parameters. However, in the case of this method, since the PTRS setting value for phase estimation must be fixed to one, the value may be selected in consideration of the worst case. Therefore, unnecessary PTRS overhead may occur depending on the situation. An example of a method in which at least one of the PTRS-related configuration information is fixed by method 1 will be described below. The disclosure is not limited to the following examples.
   PTRS ON/OFF: It may not be configured (It can be assumed that PTRS is always transmitted).
   PTRS time density (L_{PT-RS}): L_{PT-RS} can be configured to a fixed value. For example, L_{PT-RS} may be fixed to one of L_{PT-RS} ∈ {0, 1, 2, 4}. In this case, ‘0’ may indicate that no PTRS is transmitted, and 1, 2, and 4 may indicate that the PTRS is transmitted every 1, 2, and 4 OFDM symbols on time. In consideration of the worst case, L_{PT-RS} may be fixed to 1. Alternatively, the MCS range value in which L_{PT-RS} is configured may be fixed. In Table 3, the values of ptrs-MCS1, ptrs-MCS2, ptrs-MCS3, and ptrs-MCS4 may be determined as fixed values. Specifically, the value of ptrs-MCS4 is fixed as the maximum MCS value used for initial transmission in the configured MCS table, and ptrs-MCS1, ptrs-MCS2, ptrs-MCS3 may be fixed to a specific value according to the configured MCS table. Alternatively, L_{PT-RS} used may be fixed according to the modulation order used. For example, methods in which when transmitting by QPSK, L_{PT-RS} is fixed to 0, when transmitting by 16QAM, L_{PT-RS} is fixed to 4, when transmitting by 64QAM, L_{PT-RS} is fixed to 2, and when transmitting by 256QAM, L_{PT-RS} is fixed to 1 may be considered.
   PTRS frequency density (K_{PT-RS}): K_{PT-RS} can be configured to a fixed value. For example, K_{PT-RS} may be fixed to one of K_{PT-RS} ∈ {0, 2, 4}. In this case, ‘0’ may indicate that no PTRS is transmitted, and 2 and 4 may indicate that the PTRS is transmitted every 2 or 4 RBs on a frequency. Considering the worst case, K_{PT-RS} can be fixed to 2. Alternatively, a frequency range value in which K_{PT-RS} is configured may be fixed. For example, NRB0 and NRB1 may be determined as fixed values as in [Table 4] described above, or NSubCH0 and NSubCH1 may be determined as fixed values as in [Table 5].
   PTRS port-related information: It may not be configured. (Only one PTRS port is configured, and more than one DMRS port can be connected to one PTRS port.)
   PTRS power setting information: It may not be configured. (PTRS power can be scaled by one configured standard.)
   PTRS resource element offset information: It may not be configured.
When Method 1 is used, when the transmitting terminal 801 and the receiving terminal 802 communicate through a sidelink in FIG. 8, PTRS-related configuration information for the PSSCH is fixed (promised) and transmitted without additional information exchange. The terminal 801 may transmit the PSSCH 813 and the corresponding PTRS through the sidelink, and the receiving terminal 802 may receive the same.

Method 2: (Pre-)Configuration on the Terminal
This method is a method in which the setting value for the PTRS-related parameter is (pre-)configured in the terminal. Here, the term “pre-configuration” may refer to information previously stored and configured in the terminal, or may refer to information configured when the terminal previously accessed the base station. Therefore, when this method is used, the PTRS-related parameter configurations may differ between the transmitting terminal transmitting the signal in the sidelink and the receiving terminal receiving the same. Therefore, the transmitting terminal needs to inform the receiving terminal of the PTRS-related parameter configuration information used to transmit the signal. In Method 2, when there is no (pre-)configured information in the terminal, the terminal may assume a fixed parameter value, as in Method 1. In the case of method 2, one or more pieces of the following PTRS-related configuration information may be (pre-)configured in the terminal.
   PTRS ON/OFF
   PTRS time density (L_{PT-RS})
   PTRS frequency density (K_{PT-RS})
   PTRS port-related information
   PTRS power setting information
   PTRS resource element offset information
When Method 2 is used, when the transmitting terminal 801 and the receiving terminal 802 in FIG. 8 perform communication through a sidelink, data may be transmitted to the receiving terminal 802 in step 812 using the PTRS-related configuration information for the PSSCH configured in the transmitting terminal 801. At this time, since the PTRS-related configuration information for the PSSCH configured for each terminal may be different, PTRS-related information configured using the first SCI 811 may be provided to the receiving terminal 802. A method according to an embodiment of the disclosure for indicating PTRS-related information using first SCI will be described in more detail through Method 6 below. When the PC5-RRC configuration 807 between the transmitting terminal 801 and the receiving terminal 802 is available (e.g., unicast), the configured PTRS-related information may be indicated to the receiving terminal 802 through PC5-RRC. When PC5-RRC is used, the configuration values for PTRS-related parameters may be updated through RRC reconfiguration.

Method 3: (Pre-)Configuration Per Resource Pool
This method is a method in which the setting values for PTRS-related parameters are (pre-)configured for each resource pool. As described with reference to FIG. 1, when the terminal is located in a partial coverage (PC) or out-of-coverage (OOC) area in the sidelink, a resource pool is (pre-)configured. Therefore, this case is the same as method 2 above. In other words, pre-configuration may refer to information previously stored and configured in the terminal, or may refer to information configured when the terminal previously accessed the base station. However, when the terminal is in the base station in-coverage (IC) area in the sidelink, the terminal may be distinguished from method 2 above. In other words, the resource-pool-related configuration may be made through the SIB received from the base station by the terminal. Thereafter, when the terminal receives resource pool information through the RRC after RRC connection with the base station is established, the resource pool information configured through RRC may overwrite the information received through SIB. Therefore, when the terminal is in the base station in-coverage area, the terminal may receive a PTRS-related configuration value from the base station, and after the base station Uu-RRC is configured, the corresponding configuration value may be updated through RRC reconfiguration. In the case of using this method, the transmitting terminal 801 that transmits a signal on the sidelink and the receiving terminal 802 that receives the same may have different configuration information for PTRS-related parameters. In method 3, when there is no (pre-)configuration information in the resource pool, the terminal may assume a fixed parameter value, as in method 1. In the case of method 3, one or more pieces of the following PTRS-related configuration information may be (pre-)configured in the support pool.
   PTRS ON/OFF
   PTRS time density (L_{PT-RS})
   PTRS frequency density (K_{PT-RS})
   PTRS port-related information
   PTRS power setting information
   PTRS resource element offset information
In the case in which method 3 is used, when the transmitting terminal 801 and the receiving terminal 802 in FIG. 8 perform communication through a sidelink, when the transmitting terminal 801 is in a base station in-coverage (IC) area, the transmitting terminal 801 may receive resource pool information through the sidelink SIB 805, may receive PTRS-related configuration information for the PSSCH, may receive resource pool information through Uu-RRC, and may receive PTRS-related configuration information for the PSSCH after the connection of the Uu-RRC 808 is established. In contrast, when the transmitting terminal 801 is located in a partial coverage (PC) or out-of-coverage (OOC) area, a resource pool may be (pre-)configured in the transmitting terminal 801. Accordingly, the transmitting terminal 801 may receive PTRS-related configuration information for the PSSCH as (pre-)configured resource pool information. At this time, the PTRS-related configuration information for the PSSCH configured for each terminal may be different. Accordingly, alternative 1 for exchanging PTRS-related configuration information between terminals and alternative 2 for communicating without exchanging PTRS-related configuration information between terminals are proposed below.
   Alternative 1 is a method of exchanging information about PTRS-related configuration information for the PSSCH configured for each terminal. First, using the first SCI 811, the transmitting terminal 801 may indicate the receiving terminal 802 to configure PTRS-related information. A method according to an embodiment of the disclosure for indicating PTRS-related information using the first SCI 811 will be described in more detail through method 6 below. When the PC5-RRC configuration 807 between the transmitting terminal 801 and the receiving terminal 802 is available (e.g., in the case of unicast), the configured PTRS-related information may be indicated to the receiving terminal 802 through PC5-RRC. When PC5-RRC is used, the configuration values for PTRS-related parameters may be updated through RRC reconfiguration. If PC5-RRC is used, the method below may be referred to for more detailed explanation.
   Alternative 2 is a method of performing sidelink communication without exchanging PTRS-related configuration information for PSSCH between terminals when PTRS-related information is configured in the resource pool. To this end, when the transmitting terminal 801 is located in a partial coverage (PC) or out-of-coverage (OOC) area, the PTRS-related parameters in the (pre-)configuration resource pool are assumed to be fixed parameter values, as in method 1. Accordingly, the terminals 801 and 802 using the (pre-)configuration resource pool may perform sidelink communication assuming a fixed PTRS parameter. In contrast, when the terminal 801 is in a base station in-coverage (IC) area, the PTRS-related parameters are always configured in common in the resource pool. Specifically, this is a method in which, when the base station gives the resource pool information to the terminal 801 through the SIB and when the resource pool information is provided to the terminal 801 after RRC connection, the PTRS-related parameter is not configured to be UE-specific (or UE-dedicated), but the terminals 801 and 802 using the corresponding resource pool always receive common PTRS parameter configuration information. Therefore, when this method is used, sidelink signals can be transmitted and received without exchanging PTRS configuration information between sidelink terminals.
In method 3, when the transmitting terminal 801 is in a base station in-coverage (IC) area, the resource pool may be referred to as a normal resource pool, differentiated from the (pre-)configuration resource pool that is used when the transmitting terminal 801 is located in partial coverage (PC) or out-of-coverage (OOC). In this case, the normal resource pool may be configured as an exceptional resource pool. There may be the condition that the normal resource pool be configured as an exceptional resource pool. For example, the situation in which the terminal performs handover to another base station or the situation in which the terminal switches from idle to an RRC access step may correspond thereto. In the disclosure, a condition related to configuration as an exceptional resource pool is not limited thereto. In the case of performing beam operation in the sidelink, even when beam failure occurs, a condition may be configured as an exceptional resource pool. In the case of a mode 2 terminal, when the mode 2 terminal is configured as an exceptional resource pool, an operation of randomly selecting a resource may be performed instead of selecting a resource through sensing. In this way, the PTRS configuration method may be the same or may differ when the in-coverage terminal is configured as an exceptional resource pool and when the in-coverage terminal is not. If the PTRS configuration method is different, the following method may be considered.
   When configured as an exceptional resource pool, the terminal may assume a PTRS parameter as a fixed parameter value, as in method 1.
   When configured as an exceptional resource pool, it is assumed that no PTRS is transmitted by the terminal.

Method 4: Configure for SL BWP
This method is a method in which the configuration value for the PTRS-related parameter is configured for the SL BWP. The SL BWP may basically include numerology information such as subcarrier spacing (SCS), and a resource pool may be configured within the SL BWP. The SL BWP configuration may be broadcasted through the sidelink SIB and signaled to terminals only with common information, or it may be considered that the SL BWP configuration is signaled in a dedicated (UE-specific) manner to the terminal. If the SL BWP information is only supported for cell common, if PTRS-related parameters are configured in the SL BWP, terminals in the base station in-coverage (IC) area may obtain related configuration information in common. However, when the terminal is located in a partial coverage (PC) or out-of-coverage (OOC) area, the SL BWP may be (pre-)configured in the terminals. The term “pre-configuration” may refer to information previously stored and configured in the terminal, or may refer to information configured when the terminal previously accessed the base station. In this case, the (pre-)configuration SL BWP information for each terminal may be different. Therefore, when the terminal is not in an in-coverage area, PTRS information is not configured in the SL BWP, and fixed parameters as in method 1 can be used. When PTRS information is not configured in the SL BWP in method 4, the terminal may assume some fixed parameter value, as in method 1. When the terminal is in an in-coverage area, one or more pieces of the following PTRS-related configuration information may be configured in the SL BWP.
   PTRS ON/OFF
   PTRS time density (L_{PT-RS})
   PTRS frequency density (K_{PT-RS})
   PTRS port-related information
   PTRS power configuration information
   PTRS resource element offset information
In the case in which method 4 is used, when the transmitting terminal 801 and the receiving terminal 802 in FIG. 8 perform communication through a sidelink, when the transmitting terminal 801 is in a base station in-coverage (IC) area, SL BWP information may be configured through the sidelink SIB 805, and PTRS-related configuration information for the PSSCH may be configured. In contrast, when the transmitting terminal 801 is located in a partial coverage (PC) or out-of-coverage (OOC) area, PTRS-related configuration information for the PSSCH may be fixed.

Method 5: Configure for PC5-RRC
This method is a method in which a configuration value for a PTRS-related parameter is configured through PC5-RRC between terminals in a sidelink, as described through FIGS. 4 and 5. However, when PC5-RRC is supported only in the unicast method in the sidelink, the method cannot be applied to all sidelink transmission methods. In the case of using this method, the transmitting terminal 801 that transmits the signal in the sidelink determines the configuration value for the PTRS-related parameter and indicates the same as PC5-RRC, and the receiving terminal 802 receiving the same may determine the configuration of the PTRS-related parameter from the PC5-RRC configuration value. An operation in which the transmitting terminal 801 determines a configuration value for a PTRS-related parameter may be classified in mode 1 and mode 2. First, in the case of mode 2, the transmitting terminal 801 may directly select the configuration value for the PTRS-related parameter by terminal implementation. Even in the case of mode 1, the transmitting terminal 801 can directly select the configuration value by terminal implementation, but when the terminal 801 is indicated a PTRS-related parameter configuration value from the support station 803 through SIB or Uu-RRC within the base station coverage, the transmitting terminal 801 may signal the configuration therefor to the receiving terminal 802 as the configuration is through PC5-RRC. When PC5-RRC is used, the configuration values for PTRS-related parameters may be updated through RRC reconfiguration. In method 5, when there is no information configured in PC5-RRC, the terminal may assume a fixed parameter value, as in method 1. In the case of method 5, one or more pieces of the following PTRS-related configuration information may be configured in PC5-RRC.
   PTRS ON/OFF
   PTRS time density (L_{PT-RS})
   PTRS frequency density (K_{PT-RS})
   PTRS port-related information
   PTRS power configuration information
   PTRS resource element offset information
In the case in which method 5 is used, when the transmitting terminal 801 and the receiving terminal 802 communicate through a sidelink in FIG. 8, PTRS-related configuration information for PSSCH may be signaled between the transmitting terminal 801 and the receiving terminal 802 through PC5-RRC 807. Therefore, this method can be used only when PC5-RRC between terminals is supported.

Method 6: Configure on SCI
This method is a method in which a configuration value for a PTRS-related parameter is configured through SCI between terminals in a sidelink, as described with reference to FIGS. 4 and 5 above. In the case of using the method, the transmitting terminal 801 that transmits the signal in the sidelink may determine a configuration value for the PTRS-related parameter and indicate the same to the receiving terminal 802 through SCI, and the receiving terminal 802 that receives the same may determine the configuration of the PTRS-related parameter from the value configured in the SCI. An operation in which the transmitting terminal 801 determines a configuration value for a PTRS-related parameter may be classified in mode 1 and mode 2. First, in the case of mode 2, the transmitting terminal 801 may directly select the configuration value for the PTRS-related parameter by terminal implementation. Even in the case of mode 1, the transmitting terminal 801 can directly select the configuration value by terminal implementation, but when the base station 803 indicates the transmitting terminal 801 of the selection value, the transmitting terminal 801 may use the same. When using SCI, a configuration value for a PTRS-related parameter may be dynamically indicated to the receiving terminal 802 through SCI transmission. In method 6, one or more pieces of the following PTRS-related configuration information may be indicated as SCI.
   PTRS ON/OFF: 1-bit information is included in the SCI, and whether PTRS is transmitted or not (PTRS present) can be configured.
   PTRS time density (L_{PT-RS}): 1-bit or 2-bit information may be included in the SCI to indicate the time density value (L_{PT-RS}) for the PTRS pattern. In the case of indication with 2 bits, L_{PT-RS} ∈ {0, 1, 2, 4} can be used. In this case, ‘0’ may indicate that no PTRS is transmitted, and 1, 2, and 4 may indicate that the PTRS is transmitted every 1, 2, and 4 OFDM symbols in time. For example, ‘00’ may indicate that PTRS is not transmitted (L_{PT-RS}=0), ‘01’ may indicate L_{PT-RS}=1, ‘10’ may indicate L_{PT-RS}=2, and ‘11’ may indicate L_{PT-RS}=4. In the case of indication with 1 bit, L_{PT-RS} ∈ {0, 2} can be used. In this case, ‘0’ may indicate that no PTRS is transmitted, and 2 may indicate that the PTRS is transmitted every 2 OFDM symbols in time. For example, ‘0’ may indicate that no PTRS is transmitted (L_{PT-RS}=0), and ‘1’ may indicate L_{PT-RS}=2. In the case of using 1 bit, a method indicating L_{PT-PS} ∈ {0, 4} may be used. The above method describes an example of use of each bit. Therefore, in addition to the above-described method, for example, ‘00’ illustrated above may indicate L_{PT-RS}=4. In the above examples, the indication bit is 1 or 2 bits, but when more information needs to be transmitted, for example, when 3 or more bits are required, additional bits may be defined using higher-layer signaling or the like through definition in the standard protocol.
   PTRS frequency density (K_{PT-RS}): 1-bit or 2-bit information may indicate a frequency density value (K_{PT-RS}) for a PTRS pattern by including bit information in the SCI. When indicating with 2 bits, (K_{PT-RS})∈{0, 2, 4} can be used. In this case, ‘0’ may indicate that the PTRS is not repeatedly transmitted on the frequency, and 2 and 4 may indicate that the PTRS is transmitted every 2 and 4 RBs on the frequency. For example, ‘00’ may indicate that the PTRS is not transmitted repeatedly in frequency (K_{PT-RS}=0), ‘01’ may indicate K_{PT-RS}=2, ‘10’ may indicate K_{PT-RS}=4, and ‘11’ may be reserved. In the case of indication using 1 bit, K_{PT-RS} ∈ {0, 4} can be used. In this case, ‘0’ may indicate that no PTRS is transmitted, and 4 may indicate that the PTRS is repeatedly transmitted every 4 RBs on a frequency. For example, ‘0’ may indicate that no PTRS is transmitted (K_(PT-RS)=0), and ‘1’ may indicate K_{PT-RS}=4. In the case of using 1 bit above, a method indicating K_{PT-RS} ∈ {0, 2} may be used. The above method describes an example of use of each bit. Therefore, in addition to the above-described method, for example, ‘00’ illustrated above may indicate K_{PT-RS}=4. In the above example, the number of indication bits is 1 or 2 bits, but when more information needs to be transmitted, for example, when 3 or more bits are required, additional bits can also be defined using higher-layer signaling through definition in the standard protocol.
   PTRS port-related information: The number of supported PTRS ports may be indicated by SCI, or corresponding information may not be configured (at this time, only one PTRS port is configured, and one or more DMRS ports may be connected to one PTRS port).
   PTRS power configuration information: Based on [Table 6], 1 bit is included in the SCI, so that one of the two options may not be indicated or configured (the PTRS power may be scaled by one predetermined reference).
   PTRS resource element offset information: Based on [Table 7], the corresponding offset information may be indicated by SCI, and the corresponding information may not be configured (in this case, PTRS resource element offset is not supported).
When method 6 is used, when the transmitting terminal 801 and the receiving terminal 802 in FIG. 8 perform communication through a sidelink, PTRS-related information configured between the transmitting terminal 801 and the receiving terminal 802 using the first SCI 811 may be indicated to the receiving terminal 802. At this time, the first-stage SCI 811 may be decoded using the PSCCH DMRS 811 without PTRS, but the second-stage SCI 812 may be decoded using the PSSCH DMRS and PTRS.

PTRS-related information may be configured by a combination of the above-described methods. An example of a case in which one or more of the above methods are used in combination will be further described below. However, it should be noted that the disclosure is not limited to the following combinations. First, a method of configuring PTRS-related information in a sidelink and a transmission/reception procedure in the case of using both methods 1 and 5 will be described with reference to FIG. 8. In FIG. 8, when the transmitting terminal 801 and the receiving terminal 802 communicate through a sidelink, as described in method 1, a PSSCH may be transmitted based on fixed (promised) PTRS configuration information (813). However, when a PC5-RRC connection 807 between the transmitting terminal 801 and the receiving terminal 802 is established, the PTRS-related information may be configured through PC5-RRC. Therefore, in the method, the transmitting terminal 801 configures a PTRS-related parameter through PC5-RRC and signals this to the receiving terminal 802 only when PC5-RRC between terminals is supported, and in a scenario where PC5-RRC is not supported, sidelink communication is performed assuming a fixed PTRS parameter. When PC5-RRC between terminals is supported, sidelink communication may be limited to a unicast method.

Alternatively, when the method 1 and method 3 are used together, a method of configuring PTRS-related information and a transmission/reception procedure in the sidelink will be described with reference to FIG. 8. In FIG. 8, when the transmitting terminal 801 and the receiving terminal 802 perform communication through a sidelink, when the transmitting terminal 801 is in a base station in-coverage (IC) area, the transmitting terminal 801 may receive resource pool information from the base station 803 through the sidelink SIB 805 and thus PTRS-related configuration information for the PSSCH may be configured. In addition, after the connection of the Uu-RRC 808, resource pool information may be configured through Uu-RRC, and PTRS-related configuration information for PSSCH may be configured. The resource pool at this time may be called a normal pool. In contrast, when the transmitting terminal 801 is located in a partial coverage (PC) or out-of-coverage (OOC) area, a resource pool may be (pre-)configured in the transmitting terminal 801. The resource pool at this time may be called a (pre-)configured pool. In the normal pool and the (pre-)configured pool, whether or not the parameter for PTRS is fixed or configurable can be configured. In contrast, whether the parameter for PTRS is fixed or configurable is configured in the normal pool, but the parameter for PTRS may be assumed to be always fixed in the (pre-)configured pool. If a parameter for PTRS is fixed or configurable in the corresponding resource pool, corresponding information may be configured, for example, as {fixed, configurable}. If the PTRS parameter is configured as ‘fixed’, the PTRS parameter may operate as a fixed/promised PTRS parameter for PTRS according to method 1 described above. If the PTRS parameter is configured as ‘configurable’ in the normal pool, when Alternative 1 of method 3 is used, the transmitting terminal 801 may indicate the PTRS parameter determined by the base station configuration to the receiving terminal 802 using the first SCI 811. When the PC5-RRC setting 807 between the transmitting terminal 801 and the receiving terminal 802 is available (e.g., unicast), the configured PTRS-related information may be indicated to the receiving terminal 802 through PC5-RRC. Alternatively, when the PTRS parameter is configured as ‘configurable’ in the normal pool, since the PTRS parameter determined by the base station configuration is always configured commonly when alternative 2 of method 3 is used, sidelink communication can be performed without exchanging PTRS-related configuration information for PSSCH between terminals.

### Second Embodiment

In the second embodiment of the disclosure, a method of transmitting a PTRS in a sidelink and a method of multiplexing with other signals will be described. First, as a method of transmitting PTRS, the terminal may assume that PTRS exists only in a region in which the PSSCH is transmitted. For this assumption to be effective, the PSCCH DMRS should be transmitted to the PSCCH region in which the second-stage SCI is transmitted, and the PSCCH region in which the second-stage SCI is transmitted should be mapped to the resource region so that the phase estimation of the region in which the PSSCH is transmitted is not affected. If a method in which the PSCCH DMRS is not separately transmitted to the PSCCH region in which the second-stage SCI is transmitted and the second-stage SCI is decoded using the PSSCH DMRS is used, it may be difficult to estimate the phase of the PSCCH region in which the second-stage SCI is transmitted. In addition, when the PSCCH region in which the second-stage SCI is transmitted is located in the middle of the temporal region in which the PSSCH is transmitted, the PTRS is not transmitted to the PSCCH region in which the second-stage SCI is transmitted, so the phase estimation performance for the PSSCH region may be deteriorated. Specifically, when the second-stage SCI is used in the sidelink, the first-stage SCI may be transmitted in the PSCCH of the symbol region in front of the slot, and the second-stage SCI may be transmitted in the PSCCH region separated therefrom. In the disclosure, it is described that the second-stage SCI is transmitted in a PSCCH region separate from the PSCCH through which the first-stage SCI is transmitted, but it should be noted that the channel through which the second-stage SCI is transmitted may not be defined as a PSCCH. For example, it may be interpreted that the second-stage SCI is transmitted in the PSSCH region. However, the PSSCH date RE and the RE through which the second-stage SCI is transmitted can be distinguished. In other words, the PSSCH region in which data is transmitted and the PSSCH region in which second-stage SCI is transmitted may be distinguished from each other, and when second-stage SCI is interpreted as being transmitted in the PSSCH region, it should be noted that the term ‘PSCCH through which second-stage SCI is transmitted’ indicates ‘PSSCH region in which second-stage SCI is transmitted, which is different from the PSSCH region through which data is transmitted. Specifically, in the PSCCH through which the first-stage SCI is transmitted, the DMRS for the PSCCH for decoding the first-stage SCI may be transmitted for each symbol. In contrast, in the case that the second-stage SCI is transmitted on the PSSCH, the PSSCH DMRS may be used to decode the second-stage SCI. In addition, the resource region in which the second-stage SCI is transmitted may be located in the middle of the temporal region in which the PSSCH is transmitted. In this case, the following may be considered as a method for transmitting PTRS.

[How PTRS is Transmitted]
The terminal may assume that the PTRS exists in a region in which the PSSCH is transmitted.
The terminal may assume that the PTRS exists in the PSSCH region in which the second-stage SCI is transmitted.
   PSSCH through which second-stage SCI is transmitted can be decoded using PSSCH DMRS.
   PTRS transmitted in the PSSCH region in which the second-stage SCI is transmitted can be used for phase noise estimation. In this case, it may be interpreted that the PSSCH through which the second-stage SCI is transmitted is phase estimated using the PSSCH PTRS. Alternatively, it may be interpreted that the PTRS transmitted in the PSSCH region in which the second-stage SCI is transmitted is used for phase estimation of the PSSCH.

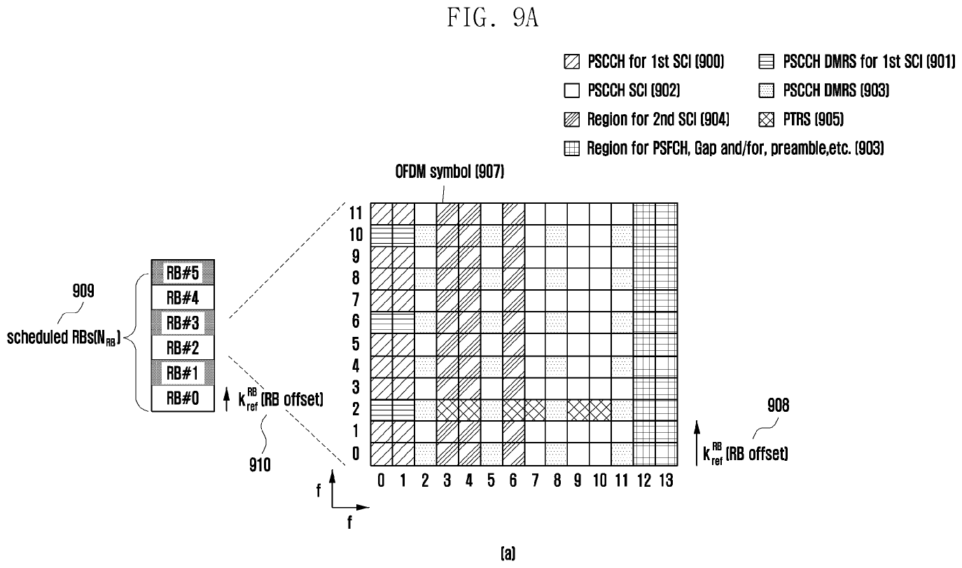

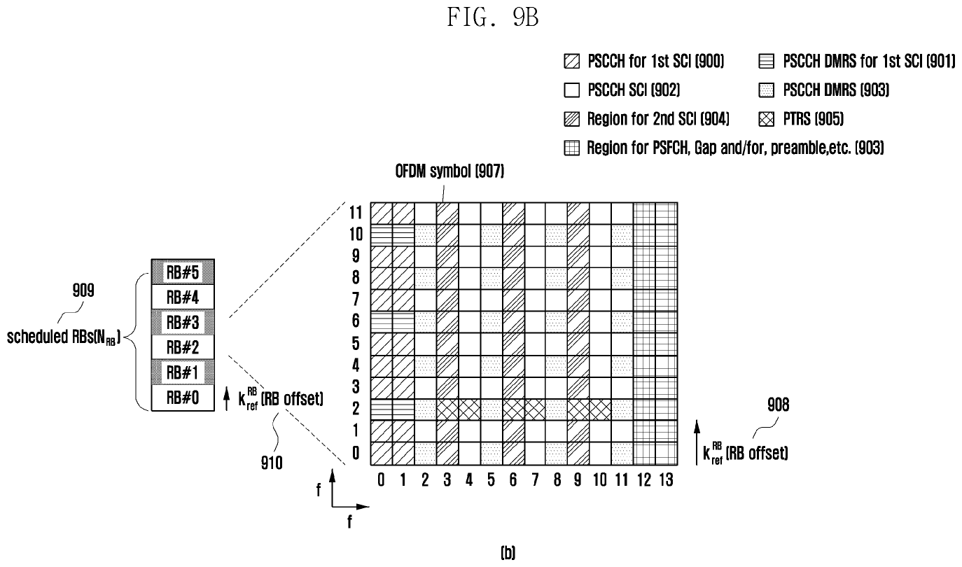

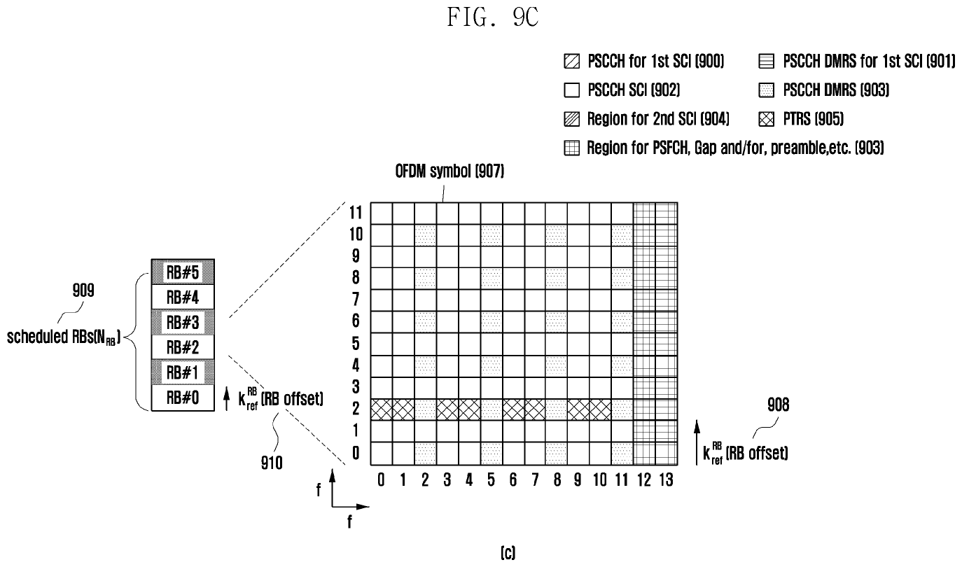

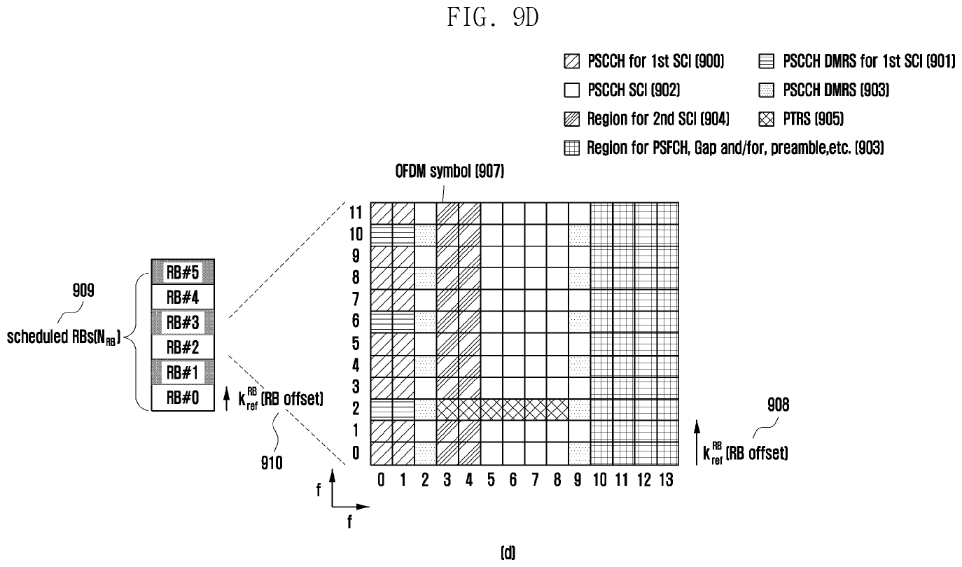

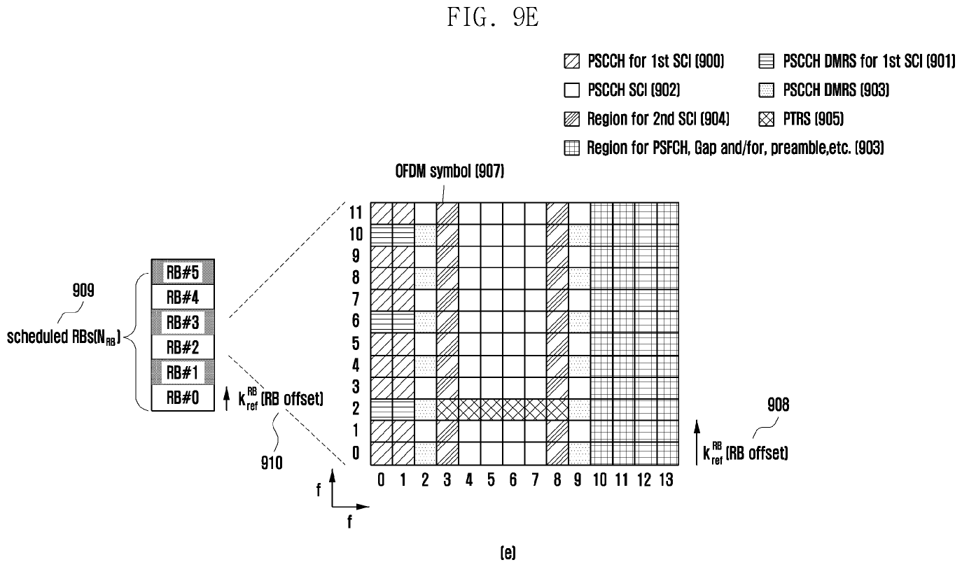

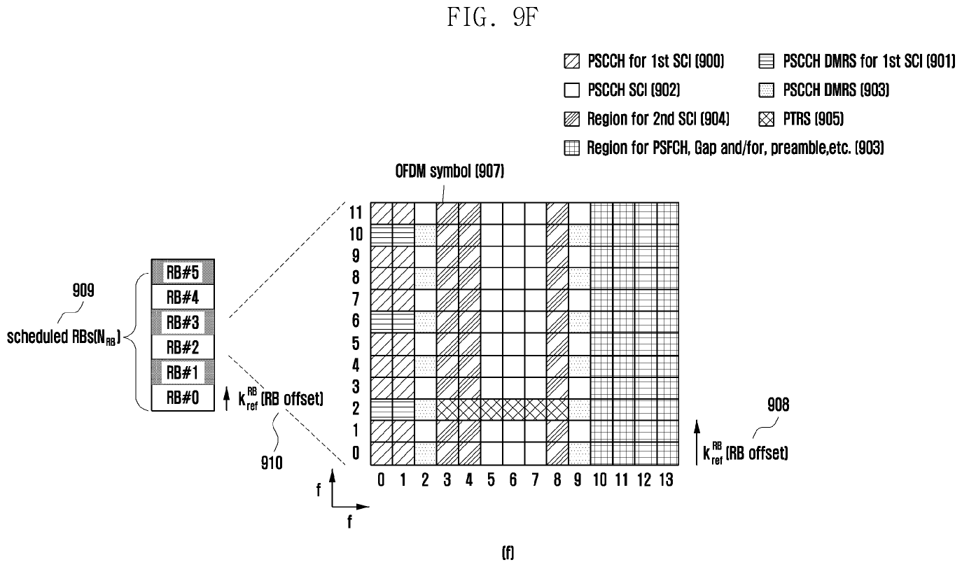

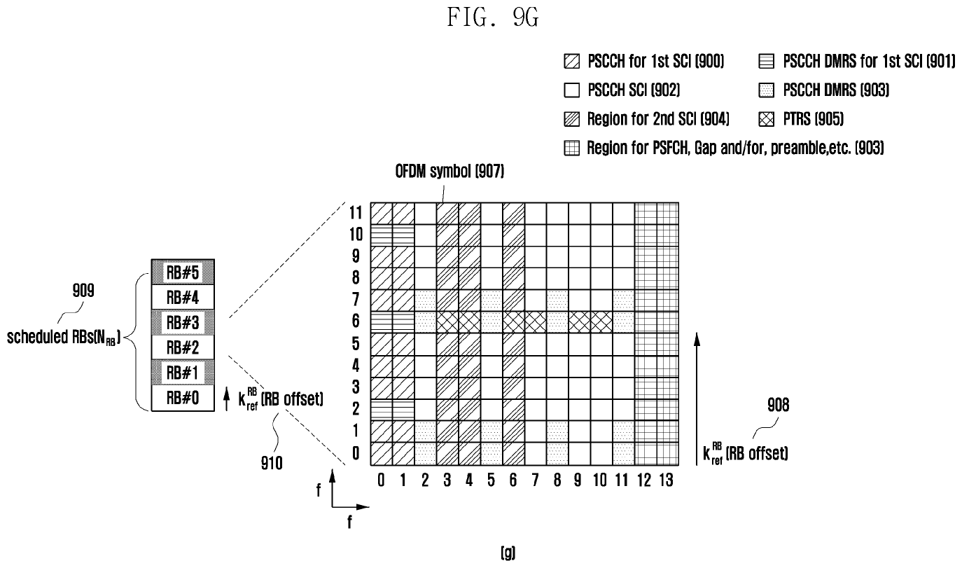

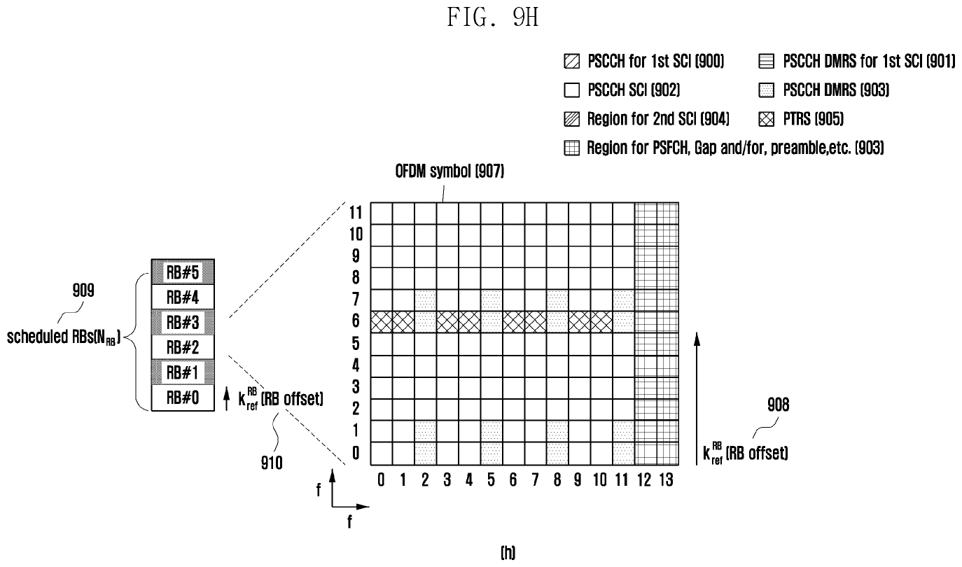

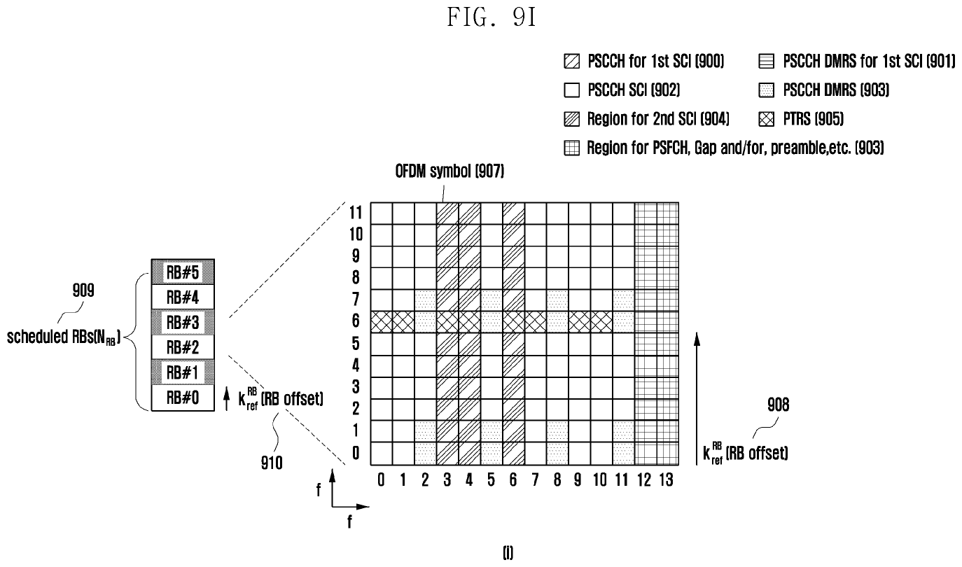

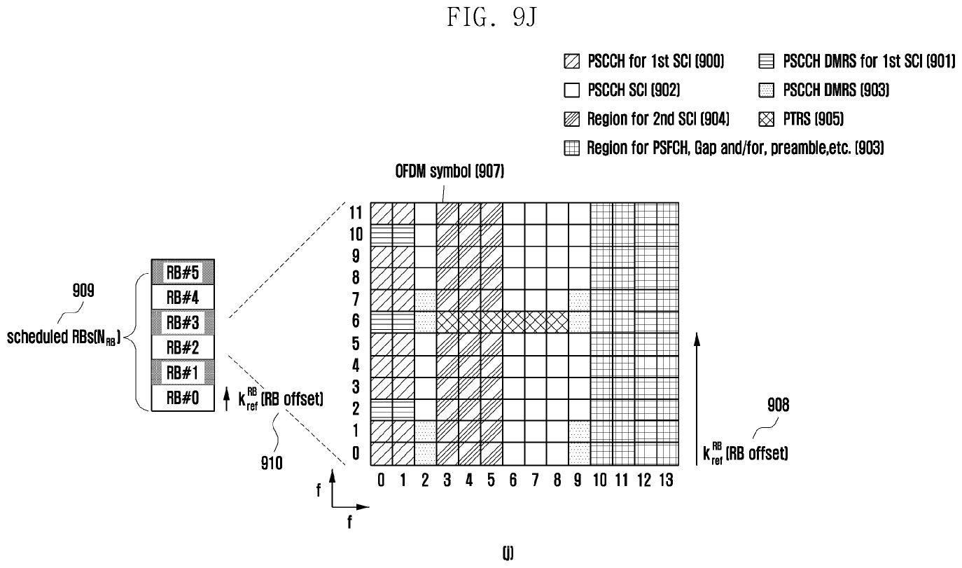

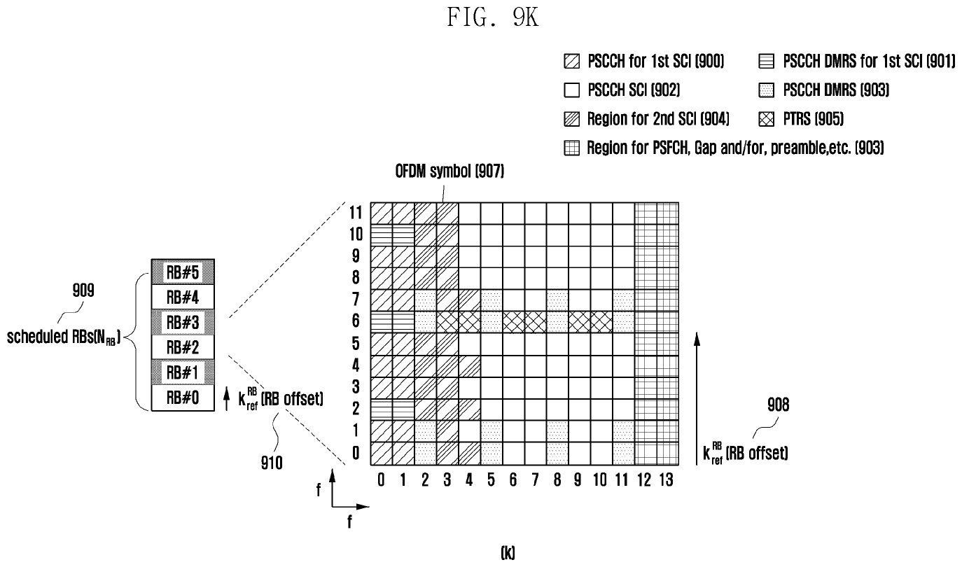

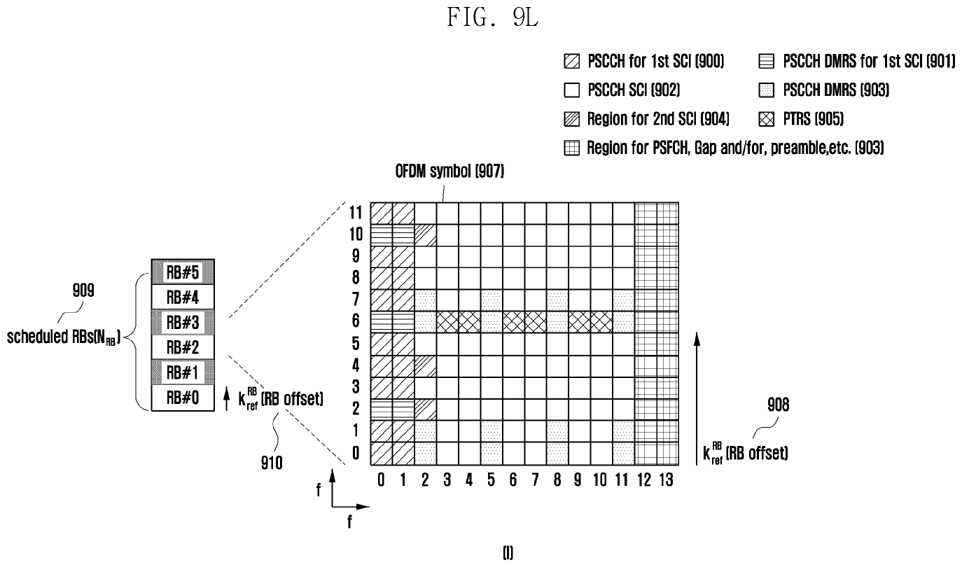

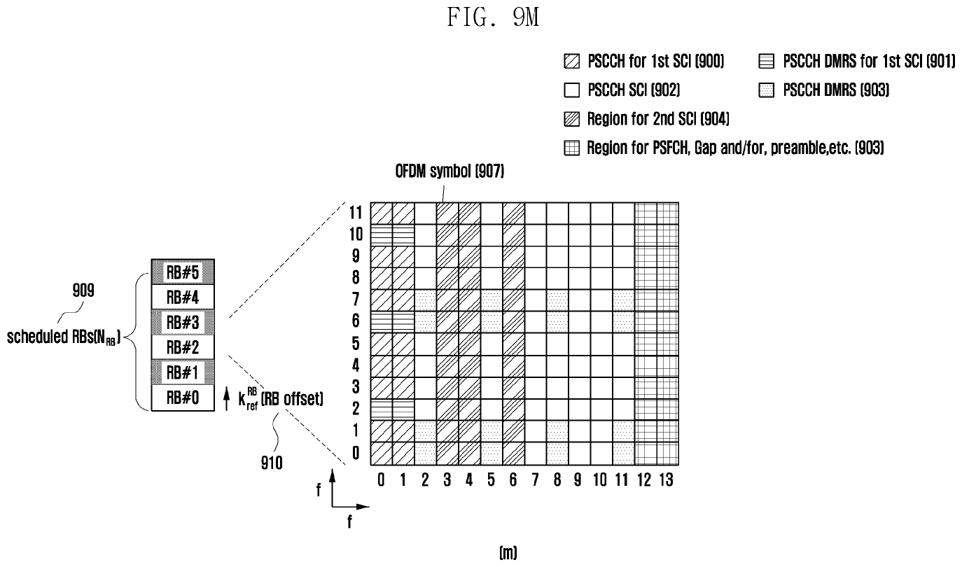

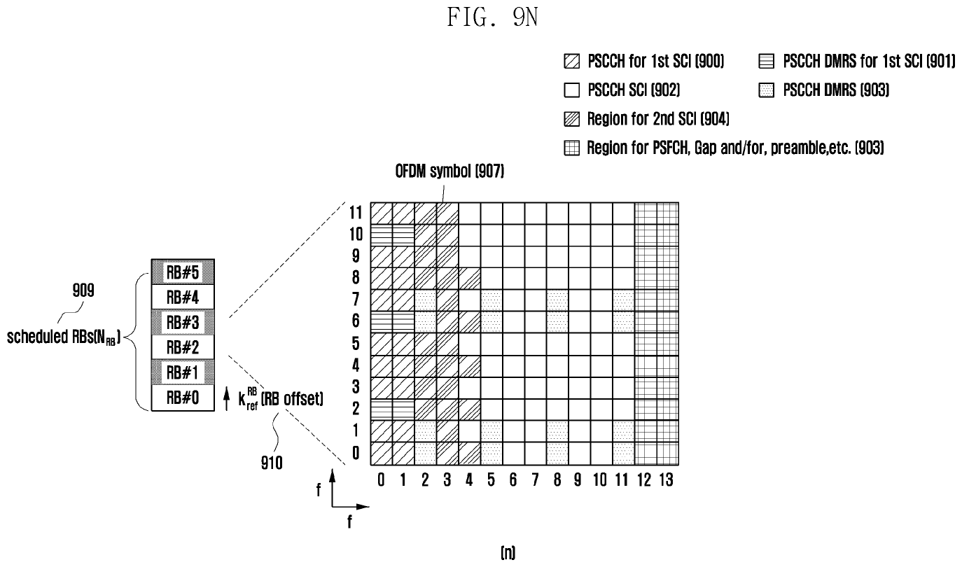

The configured PTRS transmission method will be described in more detail with reference to FIGS. 9A to 9N.

FIGS. 9A to 9N are exemplary diagrams for explaining a method for transmitting PTRS according to various embodiments of the disclosure.

In the following description, for convenience of description, the case in which reference is made to the entirety of a drawing, for example, rather than the case in which reference is made to one specific drawing, as shown in FIGS. 9A and 9B, will be referred to as FIG. 9. Referring to FIG. 9, a PSCCH 900 for transmitting first-stage SCI in sidelink, DMRS 901 for PSCCH for decoding first-stage SCI, a PSSCH 902, a PSSCH DMRS 903, a PSSCH 904 in which second-stage SCI is transmitted, a PSSCH PTRS 905, and a region 906 in which a PSFCH, a GAP, or a preamble is transmitted in a region in the last symbol of a slot are illustrated.

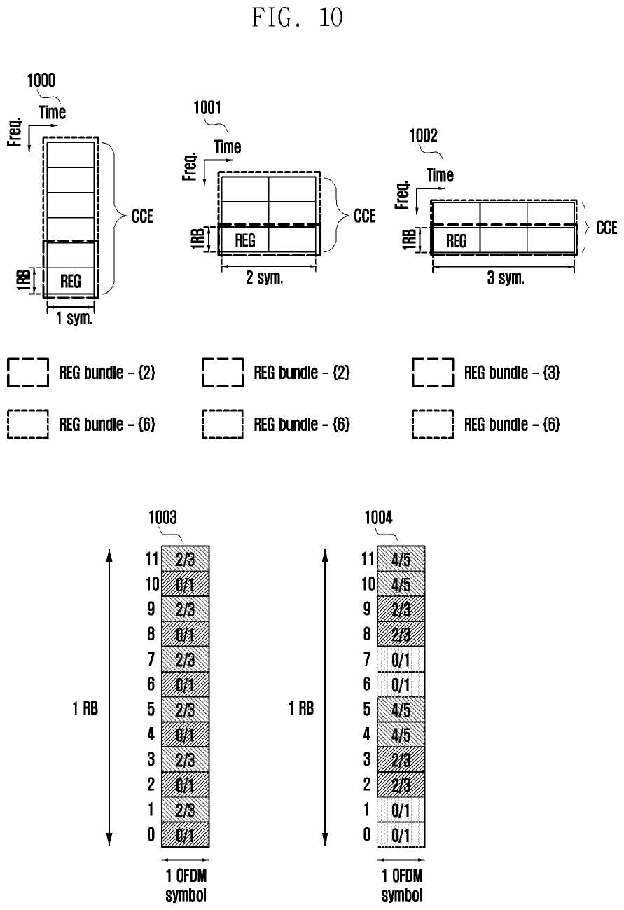

First, the PSCCH 900 in which the first-stage SCI is transmitted in the sidelink may be transmitted in a symbol region in front of the slot. The basic unit of time and frequency resources constituting the PSCCH 900 through which the first-stage SCI is transmitted may be referred to as a resource element group (REG), and the REG may be defined as 1 OFDM symbol on the time axis and 1 physical resource block (PRB) on the frequency axis, that is, 12 subcarriers. The REG may include a region to which a demodulation reference signal (DMRS), which is a reference signal for decoding the same, is mapped. As shown in FIG. 9, three DMRSs 901 may be transmitted in 1 REG. The base station may configure an allocation unit of the PSCCH 900 through which the first-stage SCI is transmitted by concatenating the REG. The basic unit to which the PSCCH 900 through which the first-stage SCI is transmitted is allocated is called a control channel element (CCE), and 1 CCE may be composed of a plurality of REG bundles. Here, the REG bundle may be composed of a plurality of REGs, and may be the minimum unit in which the PDCCH is interleaved. Structures of CCEs supported by the PSCCH 900 in which the first-stage SCI is transmitted are shown in 1000, 1001, and 1002 of FIG. 10.

FIG. 10 illustrates a diagram illustrating the structure of a CCE supported by a PSCCH through which SCI is transmitted according to various embodiments.

The structure of the CCE supported by the PSCCH through which the first-stage SCI is transmitted will be described in detail.

Referring to 1000, 1001, and 1002 of FIG. 10, the structure of a CCE corresponding to the case in which the PSCCH symbol length in which first-stage SCI is transmitted is 1, 2, and 3 may be shown. When the structure of 1000 or 1001 of FIG. 10 is used, the possible REG bundle may be 2 or 6, and when the structure of 1002 is used, the possible REG bundle may be 3 or 6. In FIG. 9, the case in which the PSCCH symbol length in which first-stage SCI is transmitted is 2 is illustrated.

Next, in FIG. 9, a region in which the PSSCH 902 is transmitted and a region in which the PSSCH DMRS 903 is transmitted are illustrated. The region in which the PSSCH 902 is transmitted may be determined by the number of symbols of the PSCCH 900 through which the first-stage SCI is transmitted and the region 906 in which the PSFCH, GAP, or preamble is transmitted in the region of the last symbol of the slot. In other words, the region in which the PSSCH 902 is transmitted may be a region from the next symbol of the PSCCH 900 in which the 1st stage SCI is transmitted in the slot, and before the region 906 in which the PSFCH, GAP, or preamble is transmitted in the region in the last symbol of the slot. In addition, the location at which the PSSCH DMRS 903 is transmitted may be determined using [Table 8] below. [Table 8] below is obtained according to a method of configuring a DMRS location corresponding to PDSCH mapping type A in Uu PDSCH. In addition, in [Table 8], the reference point l for the DMRS location is defined from the first symbol of the slot. In [Table 8], l0 may be selected as either 2 or 3 according to the maximum symbol length of the PSCCH through which first-stage SCI is transmitted. Alternatively, it may be possible to configure whether l0 is 2 or 3 in [Table 8]. In this case, the configuration may be (pre-)configured in the resource pool. Alternatively, the configuration may be dynamically indicated through SCI. In [Table 8], since the reference point l for the DMRS position is defined from the first symbol of the slot, in FIG. 9, the cases where ‘duration in symbol’ is 12 (FIGS. 9A, 9B, 9C, 9G, 9H, 9I, 9K, 9L, 9M, 9N) and 8 (FIGS. 9D, 9E, 9F, 9J) are shown in [Table 8]. However, in the disclosure, the position at which the PSSCH DMRS 903 can be transmitted is not limited to the following [Table 8]. In this embodiment, a method of determining a location to which the PSSCH DMRS 903 is transmitted will be described using [Table 8].

[Method of Supporting DMRS Pattern in Time for PSSCH]
The DMRS pattern for PSSCH is defined as single-symbol DMRS.
   In FIG. 10, two types of frequency patterns for single-symbol DMRS for PSSCH are shown. DMRS type A 1003 is a Comb 2 structure with a CS length 2 structure and is a type that supports up to 4 orthogonal DMRS ports, and DMRS type B 1004 is a type in which an orthogonal cover code (OCC) is applied to two REs adjacent to the frequency axis and FDM is applied, so that up to six orthogonal DMRS ports can be supported. In the sidelink, both patterns may be used, or only one of the two patterns may be selected and supported. If both patterns are supported, the configuration may be (pre-)configured in the resource pool. Alternatively, the configuration may be dynamically indicated through SCI.
The temporal DMRS pattern for the PSSCH can be determined according to how the single-symbol DMRS is transmitted within the symbol period in which the PSSCH is transmitted, and whether one fixed DMRS pattern or multiple temporal DMRS patterns are used for resource pool configuration may be (pre-)configured.
   If one fixed DMRS pattern is configured to be used in the resource pool configuration, the DMRS pattern in time in the PSSCH region may be determined as a DMRS pattern corresponding to dmrs-AdditionalPosition=3 by ‘duration in symbol’, based on [Table 8], in consideration of the high-speed transmission environment of the sidelink. For example, when ‘duration in symbol’ in [Table 8] is 12 with reference to FIG. 9 (FIGS. 9A, 9B, 9C, 9G, 9H, 9I, 9K, 9L, 9M, and 9N), a DMRS pattern in time in the PSSCH region is transmitted in four symbols (10, 5, 8, 11). In contrast, when the ‘duration in symbol’ in [Table 8] is 8 with reference to FIG. 9 (FIGS. 9D, 9E, 9F, 9J), a DMRS pattern in time in the PSSCH region is transmitted in two symbols (10, 7).
   If multiple time-based DMRS patterns are configured to be used in resource pool configuration, the terminal may select the corresponding pattern. In addition, the terminal may inform other terminals of the information of the selected pattern through SCI. In this case, the selectable DMRS pattern in time may be ‘dmrs-AdditionalPosition’, based on [Table 8]. The actually transmitted time-based DMRS pattern is determined by ‘duration in symbol’ and selected ‘dmrs-AdditionalPosition’, based on [Table 8]. When the terminal selects the DMRS pattern in time as dmrs-AdditionalPosition=4, when ‘duration in symbol’ in Table 8 is 8 with reference to FIG. 9 (FIGS. 9D, 9E, 9F, and 9J), a DMRS pattern in time in the PSSCH region is transmitted in two symbols (10, 7). However, when the ‘duration in symbol’ is 12 (FIGS. 9A, 9B, 9C, 9G, 9H, 9I, 9K, 9L), the DMRS pattern in time in the PSSCH region is transmitted in 4 symbols (10, 5, 8, 11).

TABLE 8

| | dmrs-AdditionalPosition | | | |
|---|---|---|---|---|
| duration in symbol | 0 | 1 | 2 | 3 |
| 2 | — | — | — | — |
| 3 | l₀ | l₀ | l₀ | l₀ |
| 4 | l₀ | l₀ | l₀ | l₀ |
| 5 | l₀ | l₀ | l₀ | l₀ |
| 6 | l₀ | l₀ | l₀ | l₀ |
| 7 | l₀ | l₀ | l₀ | l₀ |
| 8 | l₀ | l₀, 7 | l₀,7 | l₀, 7 |
| 9 | l₀ | l₀, 7 | l₀, 7 | l₀, 7 |
| 10 | l₀ | l₀, 9 | l₀, 6, 9 | l₀, 6, 9 |
| 11 | l₀ | l₀, 9 | l₀, 6, 9 | l₀, 6, 9 |
| 12 | l₀ | l₀, 9 | l₀, 6, 9 | l₀, 5, 8, 11 |
| 13 | l₀ | l₀, 11 | l₀, 7, 11 | l₀, 5, 8, 11 |
| 14 | l₀ | l₀, 11 | l₀, 7, 11 | l₀, 5, 8, 11 |

Next, FIG. 9 shows a region in which the PSSCH PTRS 905 is transmitted. First, it is assumed that PTRS time density, PTRS frequency density, and PTRS resource element offset information for PTRS are given in the sidelink. Since a detailed description of the information configuration method was made in connection with the first embodiment, a further description will be omitted. FIG. 9 shows the case in which PTRS time density is given as 1, PTRS frequency density is given as 2, and PTRS resource element offset values are given as 2 and 6 for DMRS type A 1003 and DMRS type B 1004, respectively. As shown in FIG. 9, the PTRS 905 may be transmitted in the region 902 in which the PSSCH is transmitted, and may also be transmitted in the PSCCH region 904 in which the second-stage SCI is transmitted. However, in the RE through which the PSSCH DMRS 903 is transmitted, PTRS transmission may be omitted. For example, DMRS may be used for phase tracking instead of PTRS. An example of a mapping method for method 1 is shown in FIGS. 9C and 9H. Specifically, FIG. 9C illustrates an example in which, when DMRS type A is transmitted in four symbols, a PTRS resource element offset value of 2 is applied, and thus PTRS is transmitted for each OFDM symbol. In addition, FIG. 9H illustrates an example in which, when DMRS type B is transmitted in four symbols, a PTRS resource element offset value of 6 is applied, and thus PTRS is transmitted for each OFDM symbol. As shown in FIGS. 9C and 9H, when PSSCH DMRS RE is transmitted to an RE location where PTRS is to be transmitted, PSSCH DMRS RE may replace PTRS RE.

Next, a method of multiplexing the PTRS with other signals in the sidelink will be described. In the sidelink, a method of multiplexing the PTRS with the following signals may be considered.

[How PTRS is Multiplexed with Other Signals]
PSSCH DMRS: as described above, PTRS transmission may be omitted in the RE through which PSSCH DMRS is transmitted. For example, in the RE in which the PSSCH DMRS is transmitted, configuration may be made so that PTRS is not transmitted. In addition, PSSCH DMRS may be used to perform phase estimation by replacing PTRS.
PSCCH DMRS for first-stage SCI: as described above, the PSCCH in which the first-stage SCI is transmitted may be configured so that no PTRS is transmitted. In the PSCCH through which the first-stage SCI is transmitted, phase tracking and PSCCH decoding may be performed using the DMRS of the PSCCH.
PSCCH DMRS for second-stage SCI: as described above, PTRS may be transmitted on PSSCH in which second-stage SCI is transmitted.
SL CSI-RS: When PTRS is transmitted, the SL CSI-RS may be mapped and configured not to be transmitted in a region where PTRS is transmitted. When the SL CSI-RS is transmitted in the PTRS transmission region, performance degradation may occur in determining the channel state and tracking the phase. Accordingly, when the terminal performs sidelink transmission, the PTRS and the SL CSI-RS need to be mapped and transmitted so as to avoid a collision.
S-SSB (S-SSS/PSBCH DMRS): PTRS is not transmitted in a region in which a sidelink synchronization signal block (SSB) is transmitted.

Next, in FIG. 9, the area of the PSSCH 904 in which the second-stage SCI is transmitted is shown. In this embodiment, a method of mapping the PSSCH 904 through which the second-stage SCI is transmitted to the PSSCH region 902 is proposed. FIG. 9 illustrates a case in which PTRS is transmitted, but PTRS may not be transmitted according to the description of the disclosure. In this case, the PSSCH may be transmitted in the RE in which PTRS is transmitted in FIG. 9, or the second-stage SCI may be transmitted in the RE in which PTRS is transmitted in FIG. 9 in the case that the RE in which PTRS is transmitted is region where the PSSCH in which the second-stage SCI is transmitted.

[How the PSSCH Through Which Second-Stage SCI is Transmitted is Mapped to Resources]

The PSSCH 904 through which the second-stage SCI is transmitted may be transmitted based on the first DMRS symbol, among symbols through which the DMRS 903 of the PSSCH 902 is transmitted. The following method may be considered as a detailed resource mapping method therefor. However, in the disclosure, the method in which the PSSCH 904 through which the second-stage SCI is transmitted is mapped to a resource is not limited to the following method.
Method 1: The PSSCH 904 through which the second-stage SCI is transmitted is mapped to the configured or scheduled PSSCH region, and is sequentially mapped to the symbol in which the DMRS is not transmitted and is transmitted from the next symbol of the first DMRS symbol among symbols in which the DMRS 903 of the PSSCH 902 is transmitted, in symbol units.
   An example of a mapping method for Method 1 is shown in FIGS. 9A, 9D, 9G, 9I, 9J, AND 9M. As a method of positioning the DMRS 903 in the PSSCH 902, the method for supporting a DMRS pattern in time for the DMRS PSSCH described above may be used. For example, FIG. 9A illustrates the case in which the DMRS type A is transmitted in 4 symbols and the PSSCH 904 in which the second-stage SCI is transmitted is transmitted in 3 symbols. FIG. 9D illustrates the case in which a DMRS type A is transmitted in two symbols and a PSSCH 904 in which a second-stage SCI is transmitted is transmitted in two symbols. FIG. 9G illustrates the case where the DMRS type B is transmitted in 4 symbols and the PSSCH 904 in which the second-stage SCI is transmitted is transmitted in 3 symbols. FIG. 9I illustrates the case where the DMRS type B is transmitted in 4 symbols and the PSSCH 904 in which the second-stage SCI is transmitted is transmitted in 3 symbols. FIG. 9I is an example of the case where the PSSCH 904 through which the second-stage SCI is transmitted is not transmitted. FIG. 9J illustrates the case where the DMRS type B is transmitted in two symbols and the PSSCH 904 in which the second-stage SCI is transmitted is transmitted in three symbols. FIG. 9M illustrates the case where the DMRS type B is transmitted in 4 symbols and the PSSCH 904 in which the second-stage SCI is transmitted is transmitted in 3 symbols and no PTRS is transmitted.
   As a modified method of Method 1, the PSSCH 904 through which the 2nd stage SCI is transmitted may be mapped first from a symbol closest to the symbol through which the DMRS is transmitted. The DMRS 903 of the PSSCH 902 is mapped to the PSSCH region set or scheduled in symbol units from the next symbol of the first DMRS symbol among the transmitted symbols, and is not sequentially mapped to the symbol in which the DMRS is not transmitted. Examples of such a modified method are shown in FIG. 9B, 9E, and 9F. For example, FIG. 9B illustrates a case where the DMRS type A is transmitted in 4 symbols and the PSSCH 904 in which the second-stage SCI is transmitted is transmitted in 3 symbols. FIG. 9E illustrates the case in which the DMRS type A is transmitted in two symbols and the PSSCH 904 in which the second-stage SCI is transmitted is transmitted in two symbols. FIG. 9F illustrates the case where the DMRS type A is transmitted in two symbols and the PSSCH 904 in which the second-stage SCI is transmitted is transmitted in three symbols. As shown in FIGS. 9B, 9E, and 9F, in the case of the modified method of Method 1, the PSSCH 904 in which the second-stage SCI is transmitted is transmitted to a symbol as close as possible to the symbol through which the DMRS 903 is transmitted, thereby obtaining a more accurate channel estimation value. However, since there are cases where the PSSCH symbol 904 through which the second-stage SCI is transmitted is located in front of the DMRS symbol 903 (FIG. 9E) and is not always located in the symbol closest to the DMRS (e.g., the case of FIG. 9F), Method 1 may be preferred over the modified method of Method 1.
Method 2: This is a method in which the PSSCH 904 through which the second-stage SCI is transmitted is sequentially mapped to the PSSCH region configured or scheduled from the first DMRS symbol, among symbols in which the DMRS 903 of the PSSCH 902 is transmitted, and transmitted. This method is a case in which the PSSCH 904 through which the second-stage SCI is transmitted is allowed to be mapped to some REs of the OFDM symbol.
   An example of mapping method 2 for the method is shown in FIGS. 9K, 9L, and 9N. As a method of positioning the DMRS 903 in the PSSCH 902, the method for supporting a DMRS pattern in time for the DMRS PSSCH described above may be used. If the number of coding bits in which the control information for the second-stage SCI 904 transmitted through the PSSCH 902 is transmitted is greater than the number of mappable coding bits in the corresponding OFDM symbol to be mapped, the RE interval between the control information symbols d may be configured as 1. On the other hand, if the number of coding bits for transmitting the control information for the second-stage SCI 904 transmitted to the PSSCH 902 is less than the number of bits that can be transmitted of the corresponding OFDM symbol to be mapped, the RE interval between control information symbols d may be configured as floor(number of available bits in first OFDM symbol for second-stage SCI mapping/number of unmapped bits for second-stage SCI). Here, the equation for d is not limited to the above method. The equation for d can also be expressed in other ways. For example, in the first equation, the denominator and the numerator may be divided by modulation order and expressed as d=floor (number of available REs in first OFDM symbol for second-stage SCI mapping/number of unmapped REs for second-stage SCI). Since the second equation is more convenient for explaining the mapping method in FIG. 9, the second equation will be used below.
   For example, FIG. 9K illustrates an example of a method in which the PSSCH 904 transmitting the second-stage SCI is mapped to the PSSCH region 902 according to the number of transmitted coding bits when DMRS type B is transmitted in 4 symbols, assuming that one RB is the configured or scheduled PSSCH 902. In FIG. 9K, the PSSCH 904 through which the second-stage SCI is transmitted from the third OFDM symbol can be mapped, and d is assumed to be 1 by the method 2, so that the PSSCH 904 may be mapped and transmitted to the PSSCH RE 902 through which data may be transmitted except for the DMRS 903 in the corresponding symbol. In addition, in the case of the fourth OFDM symbol in FIG. 9K, it is assumed that the number of REs to which control information for the second-stage SCI 904 is transmitted is 5, and the terminal may map the second-stage SCI 904 of 5 REs from a low RE index (or a high RE index) at d=floor((12−1)/5)=2 intervals on the frequency axis, as shown in FIG. 9K. One RE excluded during the calculation of d becomes the one RE through which the PTRS 905 is transmitted in the fourth OFDM symbol in FIG. 9K.
   For example, FIG. 9L illustrates another example of a method in which the PSSCH 904 through which the second-stage SCI is transmitted is mapped to the PSSCH region 902 according to the number of transmitted coding bits when DMRS type B is transmitted in 4 symbols, assuming that one RB is the configured or scheduled PSSCH 902. In the case of the second OFDM symbol in FIG. 9L, it is assumed that the number of REs to which control information for the second-stage SCI 904 is transmitted is 4, and the terminal may map the second-stage SCI 904 of 4 REs on the frequency axis from a low RE index (or a high RE index) with d=floor((12−4)/4)=2 intervals, as shown in FIG. 9K. The four REs excluded during the calculation of d are four REs through which the DMRS 903 is transmitted in the second OFDM symbol in FIG. 9L.
   For example, FIG. 9N illustrates another example of a method in which the PSSCH 904 through which the second-stage SCI is transmitted is mapped to the PSSCH region 902 according to the number of transmitted coding bits when DMRS type B is transmitted in 4 symbols, assuming that the PTRS 905 is not transmitted and that one RB is the configured or scheduled PSSCH 902. In the case of the second OFDM symbol in FIG. 9N, d=1 is assumed, and the PSSCH 904 through which the second-stage SCI is transmitted may be mapped to the RE in which the DMRS 903 is not transmitted. In addition, in the case of the fourth OFDM symbol in FIG. 9N, it is assumed that the number of REs to which control information for the second-stage SCI 904 is transmitted is 5, and the terminal may map the second-stage SCI 904 of 5 REs from a low RE index (or a high RE index) at d=floor(12/5)=2 intervals on the frequency axis, as shown in FIG. 9K.

### Third Embodiment

In the third embodiment of the disclosure, a method of forming an association between a PTRS port and a DMRS port in a sidelink will be described. If only one DMRS port is supported, one PTRS port is defined, and there is no need to define an association between the PTRS port and the DMRS port. However, when there are two or more DMRS ports and the number of PTRS ports is less than the number of DMRS ports, it is necessary to form an association between the PTRS ports and the DMRS ports. Specifically, when phase tracking is performed using PTRS for a channel corresponding to a DMRS port, phase tracking should be performed using a PTRS port associated with the DMRS port. Therefore, a method of forming an association between a PTRS port and a DMRS port in the case of performing codebook-based transmission in the sidelink will be described. First, the codebook used in the sidelink may be assumed to be a codebook used in the uplink in the NR Uu system. However, in the disclosure, there is no limit to the codebook that is used in the sidelink. In the case of assuming a codebook used in the uplink in the NR Uu system, the codebook may be classified into a fully coherent, partially coherent, or non-coherent codebook. In the sidelink, a method of forming an association between a PTRS port and a DMRS port may be defined by classifying the following two cases.

In the first case, when the terminal performs a sidelink CSI report, the terminal that receives the sidelink CSI report necessarily determines a transmission parameter using the reported CSI. In this method, the terminal reports the sidelink CSI, such as PMI and RI, and the terminal that receives the sidelink CSI report determines transmission parameters such as precoder or rank according to the indicated parameters. In this case, under the assumption that precoder or rank information is shared between the transmitting terminal and the receiving terminal, the transmitting terminal may indicate only the DMRS port information used (scheduled) as the receiving terminal to the SCI, and the receiving terminal may recognize the PTRS port associated with the DMRS port from the indicated DMRS port information. For example, it may be assumed that the terminal receiving the CSI report performs transmission using only one PTRS port when the terminal selects the fully coherent codebook as the PMI and performs CSI reporting. In contrast, the terminal receiving the CSI report may recognize the association information with the PTRS port from the DMRS port information indicated by SCI when the terminal selects the partially coherent or non-coherent codebook as the PMI and performs CSI reporting. Specifically, it may be assumed that the terminal receiving the SCI is associated with PTRS port 0 when DMRS ports 0 and 2 are indicated. In contrast, it may be assumed that the UE that received the SCI is associated with PTRS port 1 when DMRS ports 1 and 3 are indicated.

In contrast, the second case is a case in which the terminal freely determines transmission parameters such as Precoder or Rank by referring to the reported CSI when the terminal has performed sidelink CSI reporting. In this case, it is necessary to separately indicate the DMRS port information used (scheduled) by the transmitting terminal to the receiving terminal through SCI and the association information between the PTRS port and the DMRS port determined by the Precoder or Rank. In this case, the DMRS port information that is used (scheduled) and the association information between the PTRS port and the DMRS port may be indicated separately, or the two pieces of information may be jointly encoded and indicated.

### Fourth Embodiment

In the fourth embodiment of the disclosure, a method of forming an association between a PTRS port and a CSI-RS port in a sidelink and a method of performing beam management through the same will be described. When performing non-codebook-based transmission in the sidelink, beam operation may be performed by forming an association between the PTRS port and the CSI-RS port. First, non-codebook transmission is a method in which a codebook is not applied to PSSCH transmission. In addition, in this embodiment, since it is assumed that the CSI-RS is used, the corresponding operation may be performed in an environment in which CSI-RS transmission and CSI reporting thereof are supported. As described with reference to FIG. 7, the terminal may configure the PTRS port index in each of resources 730 and 735 using the channel-state information framework of the NR sidelink system. Accordingly, in the case of non-codebook transmission, the number of PTRS ports that are actually used and transmitted may be determined based on the CSI-RS resources 730 and 735. If the PTRS port indexes configured in different resources 730 and 735 are the same, the corresponding DMRS port may be interpreted as being associated with one PTRS port.

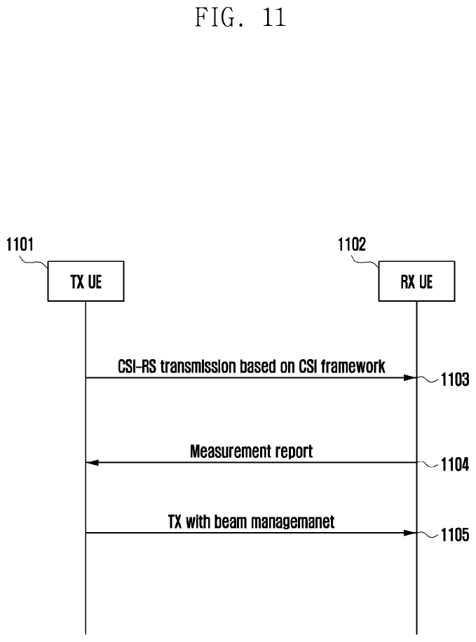

FIG. 11 illustrates a signal flow diagram illustrating a method of performing beam operation through CSI-RS resource configuration in the case of non-codebook transmission according to an embodiment.

Referring to FIG. 11, in order to perform beam operation in the sidelink, the transmitting terminal 1101 configures one or more C SI-RS resources in step 1103 and configures a PTRS port index in the CSI-RS resource to perform CSI-RS transmission. The receiving terminal 1102 may determine which resource the transmitted beam is good by performing measurement for each CSI-RS resource from the received CSI-RS. In this case, when different PTRS port indexes are configured for each CSI-RS resource, the receiving terminal 1102 may perform phase tracking using different PTRS ports for each CSI-RS resource. On the other hand, when the PTRS port indexes configured in different CSI-RS resources are the same, the receiving terminal 1102 may perform phase tracking using the same PTRS port in different CSI-RS resources. Next, in step 1104, the receiving terminal 1102 may provide a measurement report to the transmitting terminal 1101. At this time, the reported information may be a preferred CSI-RS resource indicator (CRI) determined based on measurement. More than one CRI may be reported. When more than one CRI are reported, information on preferred X CSI-RS resources may be reported based on measurement. In step 1104, the measurement report information may be RSRP corresponding to the CSI-RS resource. At this time, RSRP may be L3-RSRP or L1-RSRP. Also, in step 1104, the measurement report information may include both CRI and RSRP. Referring to FIG. 7, one reporting setting 740 and one resource setting 700 are connected according to link 760. In order to make a report on a CSI-RS resource for which a measurement report is preferred according to this embodiment, in the case of the report, only one resource set 720, 725 needs to be configured in the resource setting 700, or information on which resource set 720, 725 is connected to the reporting setting 740 needs to be configured. Next, in step 1105, the transmitting terminal 1101 may transmit a signal to the receiving terminal 1102 by selecting a beam based on the measurement report information in step 1104.

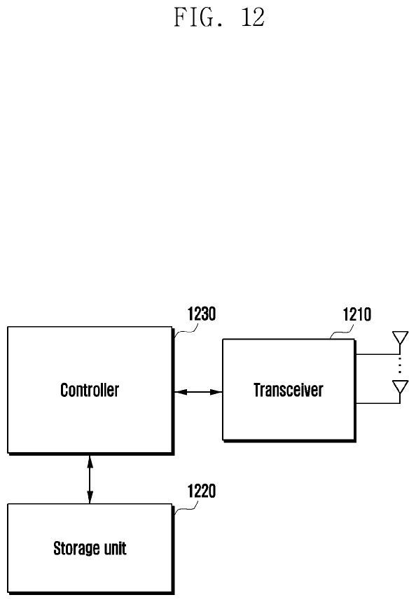

FIG. 12 illustrates the configuration of a terminal in a wireless communication system according to various embodiments.

The terms ‘. . . unit’, ‘. . . group’, and the like used below refer to a unit that processes at least one function or operation, which may be implemented by hardware or software, or a combination of hardware and software.

Referring to FIG. 12, the terminal includes a communication unit (transceiver) 1210, a storage unit 1220, and a controller 1230.

The communication unit 1210 performs functions for transmitting and receiving signals through a wireless channel. For example, the communication unit 1210 performs a function of converting between a baseband signal and a bit stream according to the physical-layer standard of the system. For example, when transmitting data, the communication unit 1210 generates complex symbols by encoding and modulating a transmission bit stream. In addition, when receiving data, the communication unit 1210 restores the received bit stream through demodulation and decoding of the baseband signal. In addition, the communication unit 1210 upconverts the baseband signal into an RF band signal, transmits the same through an antenna, and downconverts the RF band signal received through the antenna into a baseband signal. For example, the communication unit 1210 may include a transmission filter, a reception filter, an amplifier, a mixer, an oscillator, a digital-to-analog converter (DAC), an analog-to-digital converter (ADC), and the like.

In addition, the communication unit 1210 may include a plurality of transmission/reception paths. Further, the communication unit 1210 may include at least one antenna array composed of a plurality of antenna elements. In terms of hardware, the communication unit 1210 may include a digital circuit and an analog circuit (e.g., a radio-frequency integrated circuit (RFIC)). Here, the digital circuit and the analog circuit may be implemented in one package. In addition, the communication unit 1210 may include a plurality of RF chains. Furthermore, the communication unit 1210 may perform beamforming.

The communication unit 1210 transmits and receives signals as described above. Accordingly, all or part of the communication unit 1210 may be referred to as a ‘transmitter’, a ‘receiver’, or a ‘transceiver’. In addition, in the following description, transmission and reception performed through a wireless channel is used in a sense indicating that the processing as described above is performed by the communication unit 1210.

The storage unit 1220 stores data such as a basic program, an application, and configuration information for the operation of the terminal. The storage unit 1220 may be composed of volatile memory, nonvolatile memory, or a combination of volatile memory and nonvolatile memory. In addition, the storage unit 1220 provides stored data according to the request of the control unit 1230.

The controller 1230 controls the overall operation of the terminal. For example, the controller 1230 transmits and receives signals through the communication unit 1210. Also, the controller 1230 writes and reads data in the storage unit 1220. In addition, the controller 1230 may perform the functions of a protocol stack required by a communication standard. To this end, the controller 1230 may include at least one processor or microprocessor, or may be a part of a processor. In addition, a part of the communication unit 1210 and the controller 1230 may be referred to as a communication processor (CP).

According to various embodiments, the control unit 1230 may control the terminal to perform operations according to the various embodiments described above.

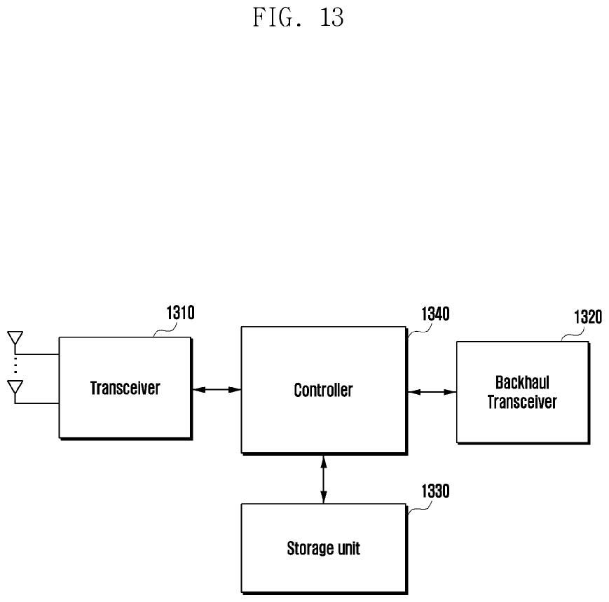

FIG. 13 illustrates the configuration of a base station in a wireless communication system according to various embodiments.

The terms ‘. . . unit’, ‘. . . group’, and the like used herein refer to a unit that processes at least one function or operation, which may be implemented by hardware or software, or a combination of hardware and software.

Referring to FIG. 13, the base station includes a communication unit (transceiver) 1310, a backhaul communication unit (backhaul transceiver) 1320, a storage unit 1330, and a controller 1340.

The communication unit 1310 performs functions for transmitting and receiving signals through a wireless channel. For example, the communication unit 1310 performs a function of converting between a baseband signal and a bit stream according to the physical-layer standard of the system. For example, when transmitting data, the communication unit 1310 generates complex symbols by encoding and modulating a transmission bit stream. In addition, when receiving data, the communication unit 1310 restores the received bit stream through demodulation and decoding of the baseband signal.

In addition, the communication unit 1310 upconverts the baseband signal into a radio-frequency (RF) band signal and then transmits the RF band signal through an antenna, and downconverts the RF band signal received through the antenna into a baseband signal. To this end, the communication unit 1310 may include a transmission filter, a reception filter, an amplifier, a mixer, an oscillator, a digital-to-analog convertor (DAC), an analog-to-digital convertor (ADC), and the like. In addition, the communication unit 1310 may include a plurality of transmission/reception paths. Further, the communication unit 1310 may include at least one antenna array including a plurality of antenna elements.

In terms of hardware, the communication unit 1310 may be composed of a digital unit and an analog unit, and the analog unit may be composed of a plurality of subunits according to operation power, operation frequency, etc. The digital unit may be implemented with at least one processor (e.g., a digital signal processor (DSP)).

The communication unit 1310 transmits and receives signals as described above. Accordingly, all or part of the communication unit 1310 may be referred to as a ‘transmitter’, a ‘receiver’, or a ‘transceiver’. In addition, in the following description, transmission and reception performed through a wireless channel is used in a sense indicating that processing as described above is performed by the communication unit 1310.

The backhaul communication unit 1320 provides an interface for performing communication with other nodes in the network. That is, the backhaul communication unit 1320 converts a bit stream transmitted from the base station to another node, for example, another access node, another base station, an upper node, a core network, etc., into a physical signal, and converts a physical signal received from another node into a bit stream.

The storage unit 1330 stores data such as a basic program, an application, and configuration information for the operation of the base station. The storage unit 1330 may be composed of volatile memory, nonvolatile memory, or a combination of volatile memory and nonvolatile memory. In addition, the storage unit 1330 provides stored data according to the request of the controller 1340.

The controller 1340 controls the overall operation of the base station. For example, the controller 1340 transmits and receives signals through the communication unit 1310 or through the backhaul communication unit 1320. In addition, the controller 1340 writes and reads data in the storage unit 1330. In addition, the controller 1340 may perform the functions of a protocol stack required by a communication standard. According to another implementation example, the protocol stack may be included in the communication unit 1310. To this end, the controller 1340 may include at least one processor.

According to various embodiments, the control unit 1340 may control the base station to perform operations according to the various embodiments described above.

Methods disclosed in the claims and/or methods according to various embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. Further, a plurality of such memories may be included in the electronic device.

In addition, the programs may be stored in an attachable storage device which may access the electronic device through communication networks such as the Internet, Intranet, Local Area Network (LAN), Wide LAN (WLAN), and Storage Area Network (SAN) or a combination thereof. Such a storage device may access the electronic device via an external port. Further, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, modifications and changes may be made thereto without departing from the scope of the disclosure. Therefore, the scope of the disclosure should not be defined as being limited to the embodiments, but should be defined by the appended claims and equivalents thereof.

What is claimed is:

1. A method performed by a first terminal in a wireless communication system, the method comprising:
transmitting, to a second terminal, first control information;
transmitting, to the second terminal, second control information; and
transmitting, to the second terminal, data based on the first control information and the second control information,
wherein symbols for transmitting the second control information starts a first symbol carrying an associated demodulation reference signal (DM-RS) for a physical sidelink shared channel.

2. The method of claim 1, further comprising:
determining symbols of the DM-RS based on a duration of a scheduled resource for transmission of the first control information and the data, a determined DM-RS time pattern, and a duration of a physical sidelink control channel.

3. The method of claim 1, further comprising:
receiving, from a base station, configuration information for a sidelink phase tracking reference signal (PTRS) per sidelink resource pool, and
wherein the configuration information for the sidelink PTRS includes at least one of a PTRS frequency density, a PTRS time density, or a PTRS resource element offset.

4. The method of claim 3, wherein resource elements for transmitting the second control information are not used for transmission of at least one of the DM-RS or the sidelink PTRS.

5. The method of claim 3, wherein the sidelink PTRS is mapped to resource elements not used for transmission of a sidelink channel state information reference signal (CSI-RS), the first control information, nor the DM-RS.

6. A method performed by a second terminal in a wireless communication system, the method comprising:
receiving, from a first terminal, first control information;
receiving, from the first terminal, second control information; and
receiving, from the first terminal, data based on the first control information and the second control information,
wherein symbols for transmitting the second control information starts a first symbol carrying an associated demodulation reference signal (DM-RS) for a physical sidelink shared channel.

7. The method of claim 6, further comprising:
determining symbols of the DM-RS based on a duration of a scheduled resource for transmission of the first control information and the data, DM-RS time pattern information received from the first terminal, and a duration of a physical sidelink control channel.

8. The method of claim 6, wherein resource elements for receiving the second control information are not used for transmission of at least one of the DM-RS or a sidelink phase tracking reference signal (PTRS).

9. The method of claim 6, wherein a sidelink phase tracking reference signal (PTRS) is mapped to resource elements not used for transmission of a sidelink channel state information reference signal (CSI-RS), the first control information, nor the DM-RS.

10. The method of claim 6, further comprising:
receiving, from a base station, configuration information for a sidelink phase tracking reference signal (PTRS) per sidelink resource pool, and
wherein the configuration information for the sidelink PTRS includes at least one of a PTRS frequency density, a PTRS time density, or a PTRS resource element offset.

11. A first terminal in a wireless communication system, the first terminal comprising:
a transceiver; and
a controller configured to:
transmit, to a second terminal via the transceiver, first control information,
transmit, to the second terminal via the transceiver, second control information, and
transmit, to the second terminal via the transceiver, data based on the first control information and the second control information,
wherein symbols for transmitting the second control information starts a first symbol carrying an associated demodulation reference signal (DM-RS) for a physical sidelink shared channel.

12. The first terminal of claim 11, wherein the controller is further configured to:
determine symbols of the DM-RS based on a duration of a scheduled resource for transmission of the first control information and the data, a determined DM-RS time pattern, and a duration of a physical sidelink control channel.

13. The first terminal of claim 11, wherein the controller is further configured to:
receive, from a base station via the transceiver, configuration information for a sidelink phase tracking reference signal (PTRS) per sidelink resource pool, and
wherein the configuration information for the sidelink PTRS includes at least one of a PTRS frequency density, a PTRS time density, or a PTRS resource element offset.

14. The first terminal of claim 13, wherein resource elements for transmitting the second control information are not used for transmission of at least one of the DM-RS or the sidelink PTRS.

15. The first terminal of claim 13, wherein the sidelink PTRS is mapped to resource elements not used for transmission of a sidelink channel state information reference signal (CSI-RS), the first control information, nor the DM-RS.

16. A second terminal in a wireless communication system, the second terminal comprising:
a transceiver; and
a controller configured to:
receive, from a first terminal via the transceiver, first control information,
receive, from the first terminal via the transceiver, second control information, and
receive, from the first terminal via the transceiver, data based on the first control information and the second control information,
wherein symbols for transmitting the second control information starts a first symbol carrying an associated demodulation reference signal (DM-RS) for a physical sidelink shared channel.

17. The second terminal of claim 16, wherein the controller is further configured to:
determine symbols of the DM-RS based on a duration of a scheduled resource for transmission of the first control information and the data, DM-RS time pattern information received from the first terminal, and a duration of a physical sidelink control channel.

18. The second terminal of claim 16, wherein resource elements for receiving the second control information are not used for transmission of at least one of the DM-RS or a sidelink phase tracking reference signal (PTRS).

19. The second terminal of claim 16, wherein a sidelink phase tracking reference signal (PTRS) is mapped to resource elements not used for transmission of a sidelink channel state information reference signal (CSI-RS), the first control information, nor the DM-RS.

20. The second terminal of claim 16, wherein the controller is further configured to:
receive, from a base station via the transceiver, configuration information for a sidelink phase tracking reference signal (PTRS) per sidelink resource pool,
wherein the configuration information for the sidelink PTRS includes at least one of a PTRS frequency density, a PTRS time density, or a PTRS resource element offset.
